(19) United States
(12) Patent Application Publication
(10) Pub. No.: US 2019/0132650 A1
(43) Pub. Date: May 2, 2019

(54) PROVIDING A SLIDE SHOW IN A LIVE VIDEO BROADCAST

(71) Applicant: Facebook, Inc., Menlo Park, CA (US)

(72) Inventor: George Lewis Kedenburg, III, San Francisco, CA (US)

(21) Appl. No.: 15/795,669

(22) Filed: Oct. 27, 2017

(51) Int. Cl. H04N 21/81; H04N 21/2187; H04N 21/4223; H04N 21/431

(52) U.S. Cl. CPC H04N 21/8153; H04N 21/4312; H04N 21/4223; H04N 21/2187

(57) ABSTRACT

The present disclosure is directed toward systems and methods for providing a slide show of digital media items in a live video broadcast. For example, systems and methods described herein enable a broadcaster to select one or more digital media items for inclusion in a live video broadcast while the broadcast is on-going. Additionally, systems and methods described herein allow the broadcaster to manipulate or otherwise enhance digital media items that have been added to a live video broadcast slideshow. Upon completion of the live video broadcast, systems and methods further generate a networking system album of the digital media items included in the live video broadcast slideshow.

### BACKGROUND

Live video broadcasting is increasingly popular among mobile device users. For example, users find it engaging to broadcast live video from their mobile phones for friends to watch. In this way, friends, family members, and colleagues are able to connect with each other in a live forum where feedback and reactions are genuine and unrehearsed.

Several problems exist, however, with conventional live video broadcasting systems and services. For example, conventional broadcasting applications often include a variety of controls and features. This is problematic when broadcasting from a mobile device as the mobile device display is typically very small and easily overwhelmed by a wide selection of buttons, sliders, dropdowns, and other display features. Additionally, broadcasters often find it difficult to maintain the rhythm and timing of their live video broadcast when they have too many controls to navigate and configure while the broadcast is live. Thus, broadcasters tend to avoid including additional features to their live video broadcasts when broadcasting from a mobile device.

Moreover, conventional broadcasting applications generally limit the broadcaster to broadcasting a simple video feed from a video camera, thereby limiting live video broadcasters from including other types of digital media content as part of a live video broadcast. For instance, a live video broadcaster generally cannot include digital media including digital photographs and videos on the fly as part of his live video broadcast. Instead, conventional systems limit a broadcaster to features such as “desktop sharing,” which consists of the broadcaster simply narrating a display of his computer desktop. The resulting shared video of the broadcaster's desktop is often unprofessional, and may even inadvertently display content (e.g., documents, files, etc.) that the broadcaster did not intend to share.

Thus, a need exists for a robust system that enables a live video broadcaster to share additional types of digital content in a live video broadcast, and to easily configure from a mobile device such that the end viewer experience is professional and engaging.

### SUMMARY

One or more embodiments described herein provide benefits and/or solve one or more of the foregoing or other problems in the art with systems, methods, and computer readable media for including digital media in a live video broadcast. For example, the systems and methods described herein provide easy and intuitive broadcaster controls that allow a broadcaster to select, display, and manipulate digital media items during a live video broadcast. Furthermore, systems and methods described herein enable the broadcaster to include digital media items in a live video broadcast without opening additional applications, switching focus away from the live video broadcast, displaying unnecessary documents or files, and so forth. As such, systems and methods described herein provide a live video broadcast that is engaging and professional from a single application on a mobile device.

The following description sets forth additional features and advantages of one or more embodiments of the disclosed systems and methods. In some cases, such features and advantages will be obvious to a skilled artisan from the description or may be learned by the practice of the disclosed embodiments.

### BRIEF DESCRIPTION OF THE DRAWINGS

The detailed description refers to the drawings briefly described below.

FIG. 1 illustrates an environmental diagram of a broadcast management system in accordance with one or more embodiments;

FIGS. 2A-2R illustrate a series of graphical user interfaces illustrating various features in accordance with one or more embodiments;

FIGS. 3A-3D illustrate a series of graphical user interfaces illustrating various features in accordance with one or more embodiments;

FIG. 4 illustrates a detailed schematic diagram of the broadcast management system in accordance with one or more embodiments;

FIG. 5 illustrates a flowchart of a series of acts in a method of including a slide show of digital media items in a live video broadcast in accordance with one or more embodiments;

FIG. 6 illustrates a block diagram of an exemplary computing device in accordance with one or more embodiments;

FIG. 7 is an example network environment of a networking system in accordance with one or more embodiments; and

FIG. 8 illustrates a social graph in accordance with one or more embodiments.

### DETAILED DESCRIPTION

One or more embodiments described herein provide benefits and/or solve one or more of the foregoing or other problems in the art with systems, methods, and computer readable media for providing a slide show of digital media items during a live video broadcast. For example, a broadcast management system described herein provides a broadcaster the ability to quickly and easily select digital media items to display during a live video broadcast from a mobile device. Furthermore, the broadcast management system also enables the broadcaster to manipulate or enhance a selected digital media item in various ways within the live video broadcast, such that a broadcast viewer can watch, in real-time, as the broadcaster zooms in on a digital photograph, doodles on a digital video, and so forth.

One example of the broadcast management system enables a broadcaster to initiate a live video broadcast from a mobile device by providing a video stream from the mobile device to a networking system (e.g., a social networking system and/or corresponding applications). The broadcast management system then provides the live video broadcast, via networking system in real-time, to additional networking system users. For example, the networking system provides the live video broadcast to networking system users who are associated with the broadcaster via the networking system (e.g., the broadcaster's friends or followers). The viewers can then view and engage with the live video broadcast (e.g., they can submit comments and likes related to the live video broadcast).

As will be explained in more detail below, during the live video broadcast, the broadcast management system provides the broadcaster with tools that enable the broadcaster to share a slide show of digital media items via the live video broadcast. For example, without requiring the broadcaster to open any additional applications or interfaces, the broadcast management system (e.g., via a mobile application on the broadcaster's mobile device) provides a display of digital media items stored on the mobile device. In additional embodiments, the broadcast management system provides a display of digital media items associated with the broadcaster via the networking system.

In one or more embodiments, in response to a detected selection of a provided digital media item, the broadcast management system adds the selected digital media item to the live video broadcast. For example, where the broadcast management system previously provided a video stream (e.g., including a video layer and an audio layer captured by a camera associated with the mobile device) from the mobile device to the networking system, in response to a selection of a digital media item, the broadcast management system (e.g., the broadcaster's device) generates a composite video stream including both the mobile device video stream (as captured by the device's camera) and the selected digital media item. The broadcast management system then replaces the originally provided video stream by providing the composite video stream to the networking system. Thus, the resulting composite video stream includes the video and audio layers of the captured video stream composited with any display and audio layers included in the digital media item. In one or more embodiments, the broadcast management system provides a seamless display of the composite video stream to the broadcaster such that the broadcaster can see exactly what the viewers of the live video broadcast are seeing.

Once the broadcast management system adds the composite video stream to the live video broadcast, the broadcast management system also enables the broadcaster to manipulate and/or enhance the added digital media item in real-time. For example, the broadcast management system enables the broadcaster to zoom in on the digital media item, zoom out from the digital media item, pan across the digital media item, twist the digital media item, doodle on the digital media item, add an overlay to the digital media item, and so forth. In one or more embodiments, the broadcast management system enables the broadcaster to manipulate and/or enhance the digital media item without needing any additional applications or display windows. In this way, the broadcast management system enables the broadcaster to create an engaging and fun live video broadcast that displays to the broadcaster's audience of viewers only what the broadcaster intends to display.

The broadcast management system enables the broadcaster to add any number of digital media items to a slide show during a live video broadcast. Further, the broadcast management system enables the broadcaster to navigate backwards and forwards through the slide show in real-time. Thus, during a live video broadcast, the broadcast management system enables the broadcaster to narrate a selection of digital media items while adding interest and excitement to the narration with not only the broadcaster's own gestures and articulations (e.g., captured by the video stream emanating from the mobile device), but also with manipulations and enhancements to the digital media items in the composite video stream.

In at least one embodiment, once the live video broadcast ends, the broadcast management system generates a networking system album including the digital media items from the slide show displayed during the live video broadcast. For example, the broadcast management system tracks any networking system activity (e.g., likes, comments, etc.) associated with each digital media item from the slide show, along with any manipulations and/or enhancements configured by the broadcaster relative to each digital media item. The broadcast management system then compiles the digital media items and their associated tracked information into a networking system album. In at least one embodiment, the broadcast management system allows the broadcaster to remove digital media items from the generated album, to edit networking system activities associated with any of the digital media items in the generated album, to add captions to any of the digital media items in the generated album, and so forth.

In additional embodiments, the broadcast management system also generates a networking system post associated with the networking system album. The broadcast management system can provide the generated post to the networking system for distribution to additional networking system users. In one embodiment, the broadcast management system configures the generated post to be provided only to networking system users who viewed the live video broadcast. In other embodiments, the broadcast management system can configure the generated post to be provided to networking system users who engaged in networking system activities associated with digital media items displayed during the live video broadcast, to networking system users who have a threshold relationship coefficient with the broadcaster, or to all of the broadcaster's networking system friends.

Thus, the broadcast management system offers significant advantages over conventional broadcasting applications in several ways. For example, the broadcast management system enables the broadcaster to easily and quickly add and narrate a slide show of digital media items in a live video broadcast without any additional applications or display windows. Additionally, the broadcast management system also enables the broadcaster to manipulate and enhance the digital media items without cluttering the limited display of a mobile device with unneeded tools and controls. As such, the broadcast management system creates computational efficiencies relative to the mobile device, as well as user efficiencies for the live video broadcaster.

Moreover, the broadcast management system offers additional computational efficiencies. For example, by generating a composite video stream including a mobile device video stream and a selected digital media item, the broadcast management system transmits a single, robust video stream, rather than multiple video and/or data streams. Thus, the broadcast management system requires fewer communication channels to transmit a large amount of display data to a potentially large audience of viewers. Furthermore, because the broadcast management system generates the composite video stream at the mobile device prior to transmission to the server, the broadcast management system also reduces the amount of back-end processing required at the server level.

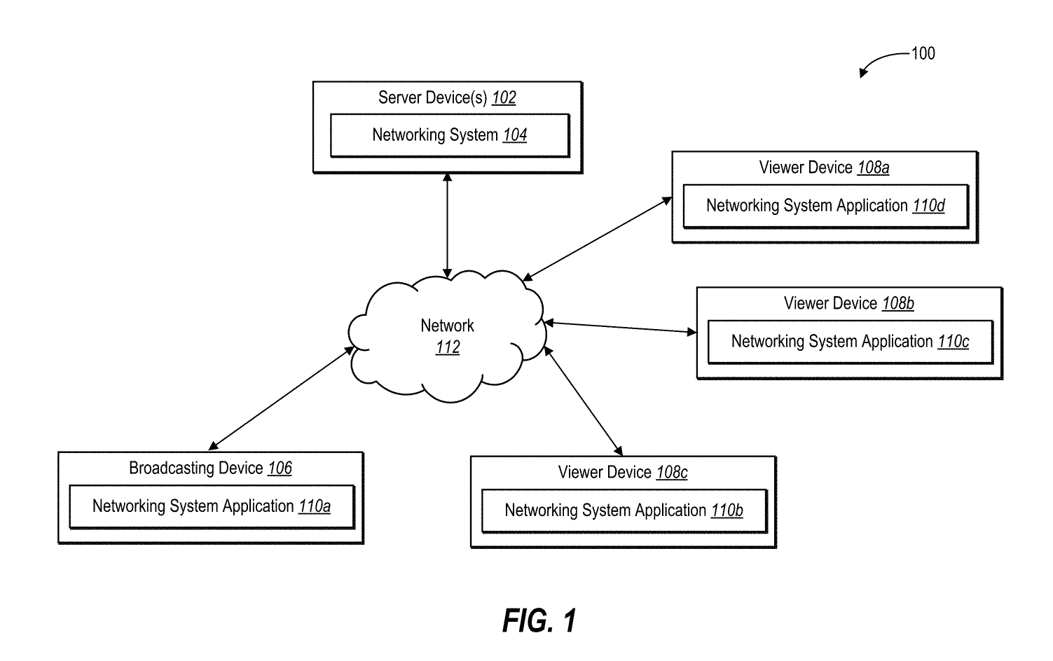

FIG. 1 illustrates an example block diagram of an environment for implementing the broadcast management system 100. As illustrated in FIG. 1, the broadcast management system 100 includes a server device(s) 102 hosting a networking system 104. Further shown in FIG. 1, the broadcast management system 100 also includes a broadcasting device 106 and viewer devices 108a, 108b, and 108c. Each of the broadcasting device 106 and the viewer devices 108a, 108b, and 108c include a networking system application 110a-110d, respectively.

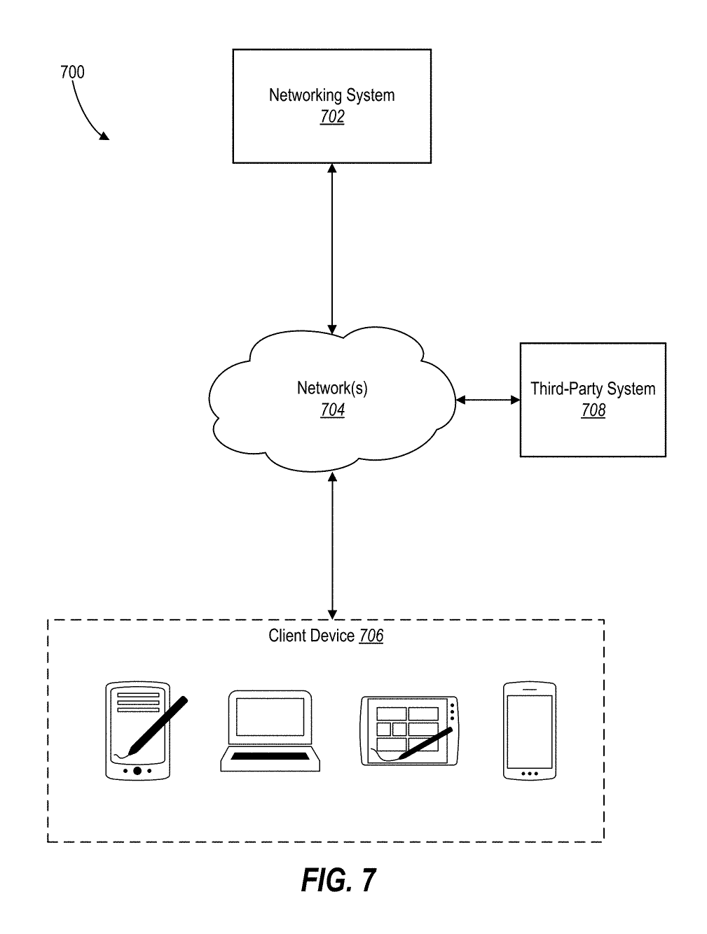

The broadcasting device 106, the viewer devices 108a-108c, and the server device(s) 102 communicate via a network 112, which may include one or more networks and may use one or more communication platforms or technologies suitable for transmitting data and/or communication signals. In one or more embodiments, the network 112 includes the Internet or World Wide Web. The network 112, however, can include various other types of networks that use various communication technologies and protocols, such as a corporate intranet, a virtual private network (“VPN”), a local area network (“LAN”), a wireless local network (“WLAN”), a cellular network, a wide area network (“WAN”), a metropolitan area network (“MAN”), or a combination of two or more such networks. Additional details relating to the network 112 are explained below with reference to FIG. 7.

Although FIG. 1 illustrates a particular number and arrangement of devices, in additional embodiments, the broadcasting device 106 and the viewer devices 108a-108c may directly communicate with the server device(s) 102, bypassing the network 112. Further, in other embodiments, the broadcast management system 100 may include any number of viewer devices as well as additional client devices authorized to interact with the broadcasting device 106, the detail of which will be provided further below. Additionally, in other embodiments, any of the viewer devices 108a-108c may act as broadcasting devices. In other words, in at least one embodiment, the networking system application 110 enables a client-computing device to act as a broadcasting device or a viewer device.

In one or more embodiments, the broadcasting device 106 and the viewer devices 108a-108c is one of various types of computing devices. For example, each of the broadcasting device 106 and the viewer devices 108a-108c may include a mobile device, such as a mobile telephone, a smartphone, a PDA, a tablet computing device, or a laptop computer. Additionally or alternatively, the broadcasting device 106 and the viewer devices 108a-108c may include a non-mobile device such as a desktop computer, a server computing device, or another type of computing device. It will be understood that the broadcasting device 106 and the viewer devices 108a-108c can include the same type of computing functionality. In other words, in a preferred embodiment, the broadcasting device 106 and the viewer devices 108a-108c are mobile computing devices such as smartphones and/or tablets.

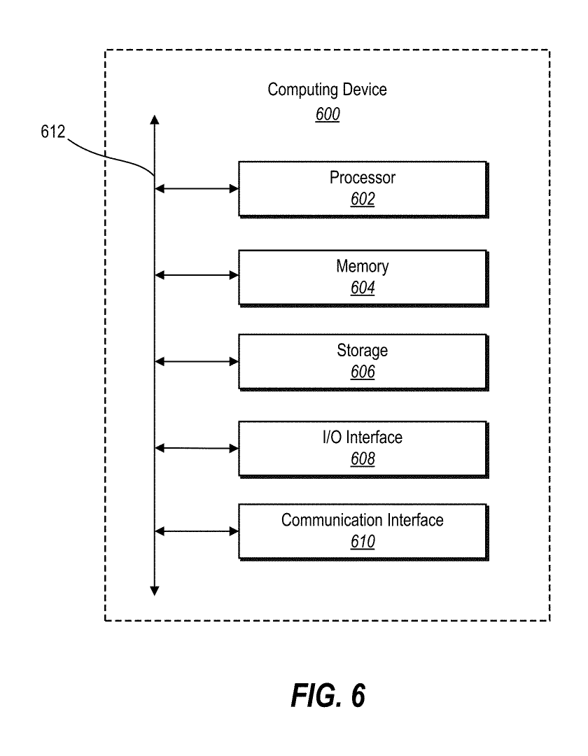

In one or more embodiments, the broadcasting device 106 is simply the computing device where a live video broadcast originates, while the viewer devices 108a-108c are the computing devices where the live video broadcast is viewed. In at least one embodiment, the user of the broadcasting device 106 (e.g., the broadcaster) and the users of the viewer devices 108a-108c (e.g., the viewers) are associated (e.g., “friends”) via the networking system 104. Additional details with respect to the broadcasting device 106 and the viewer devices 108a-108c are discussed below with respect to FIG. 6.

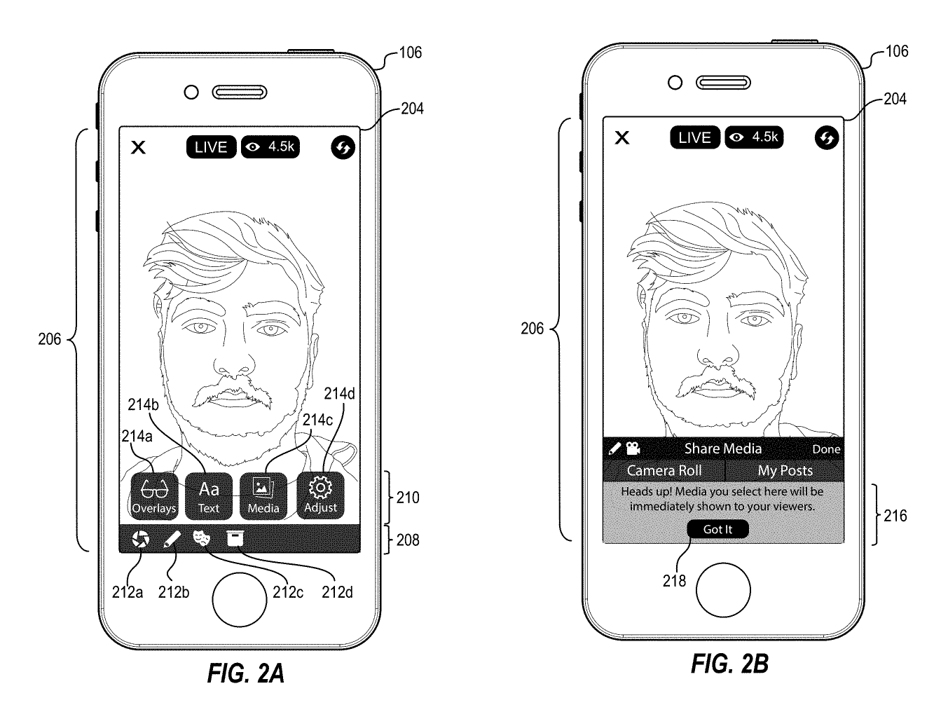

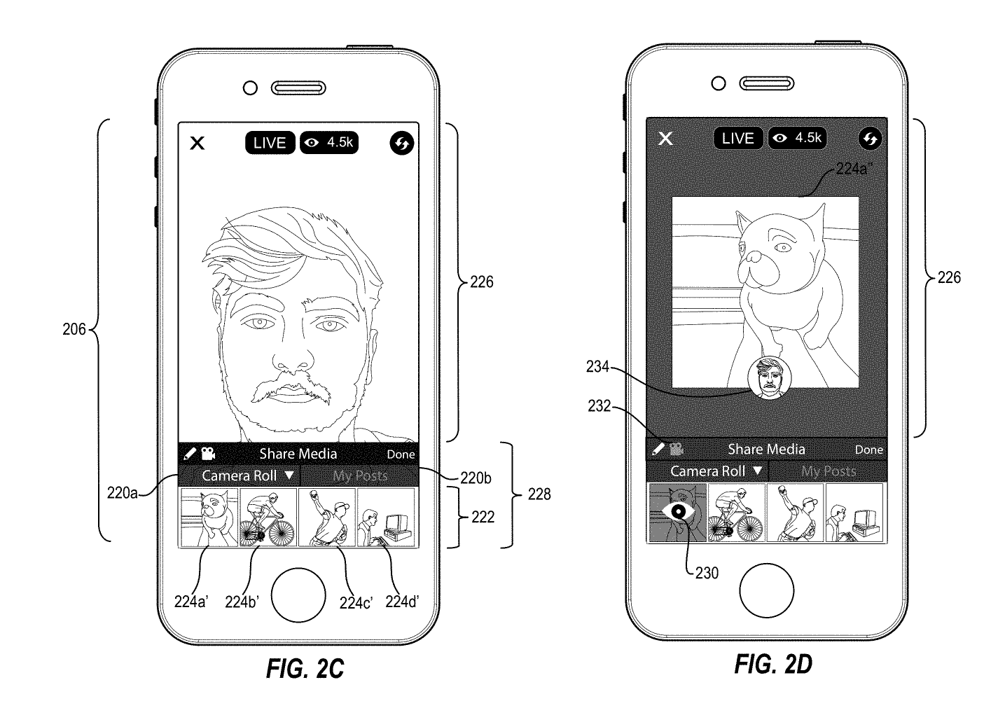

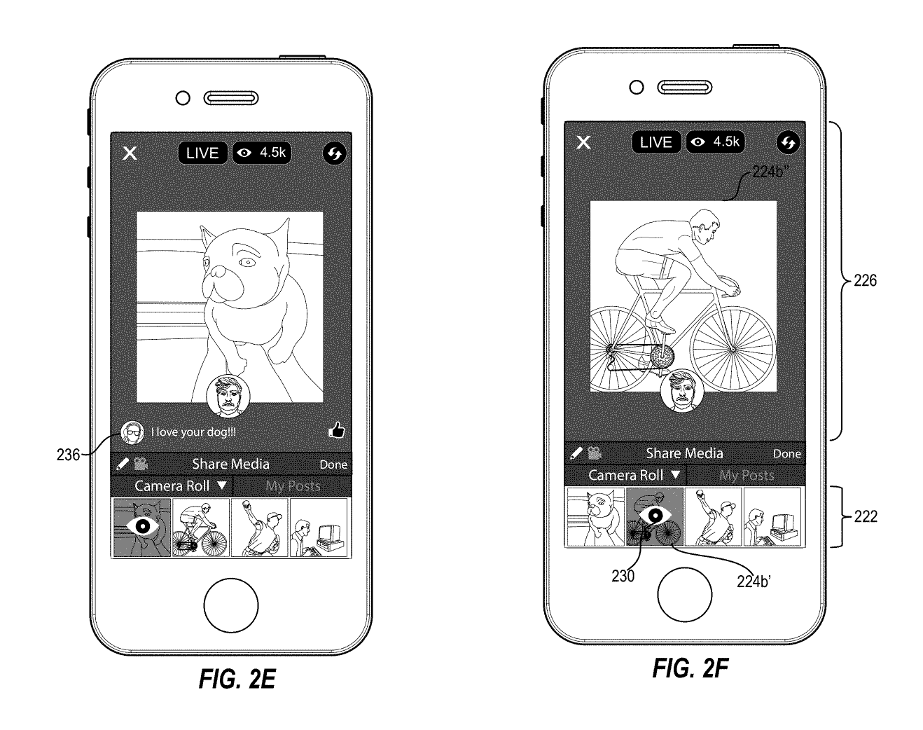

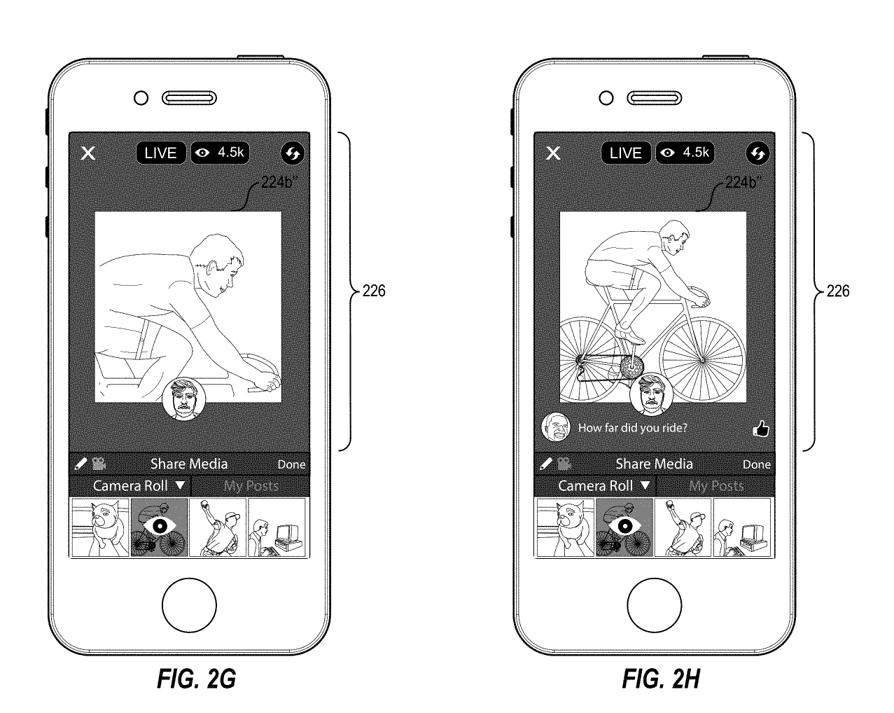

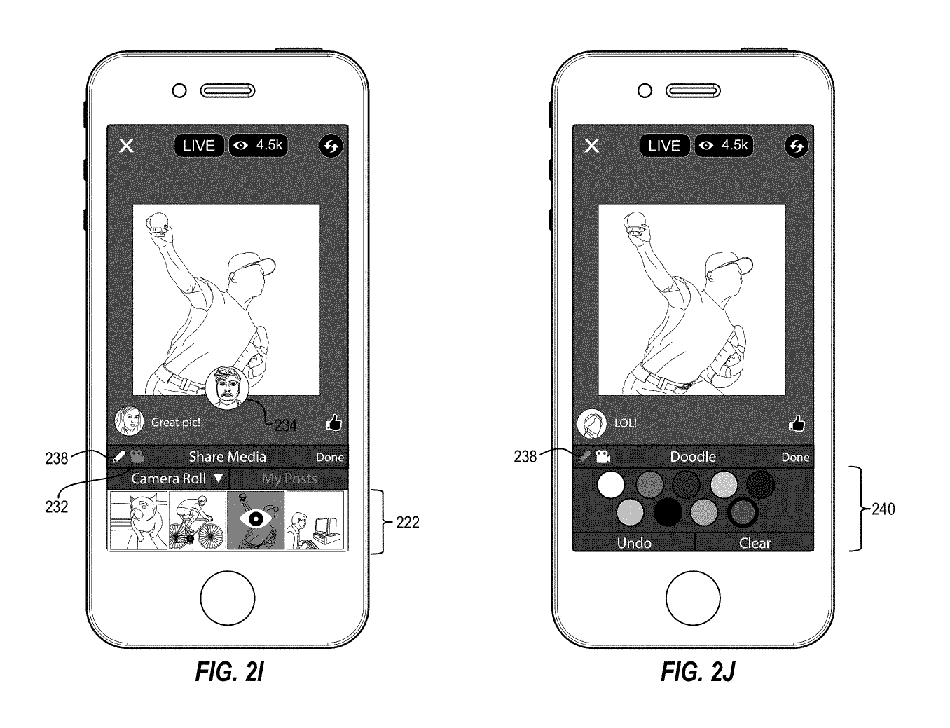

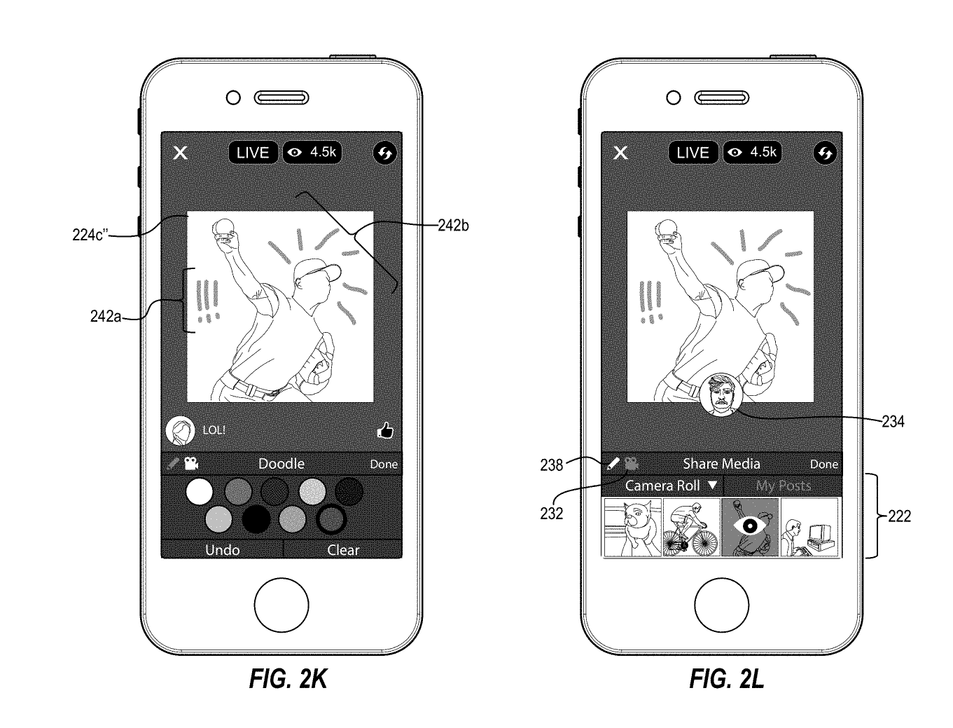

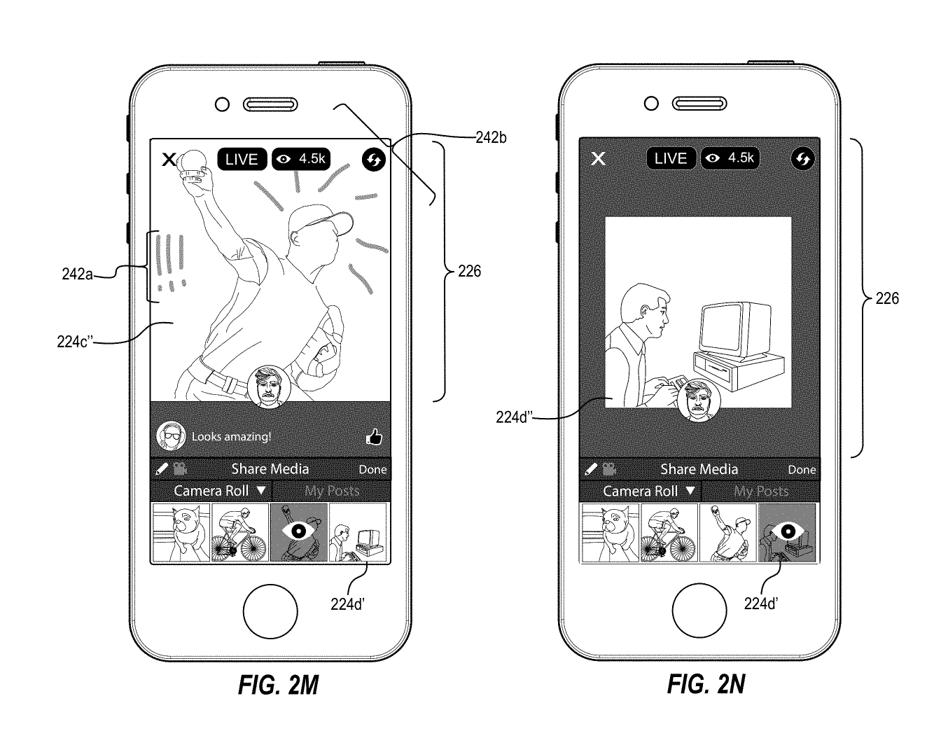

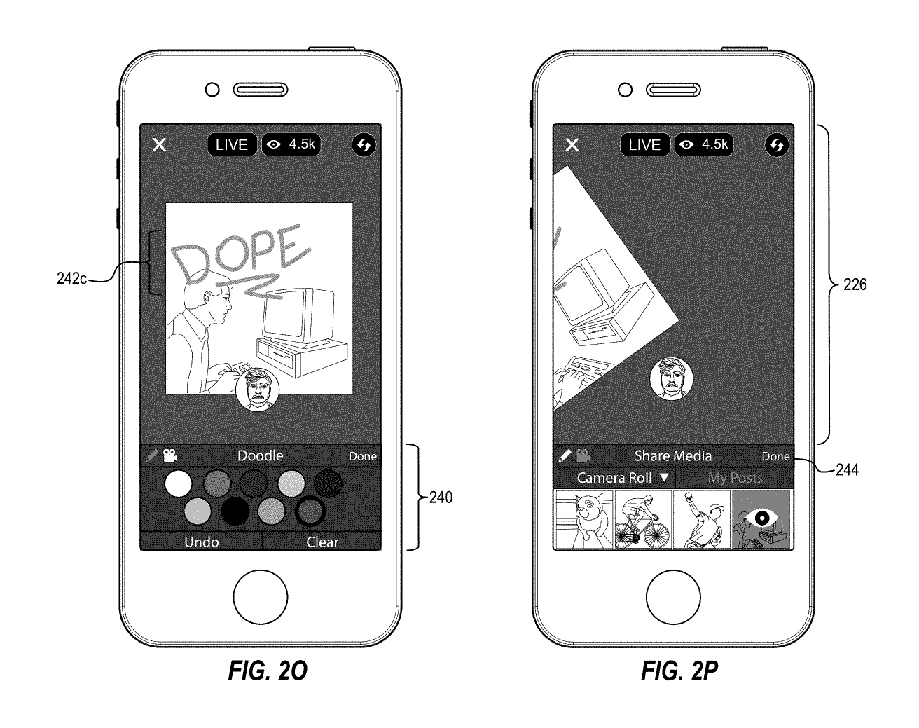

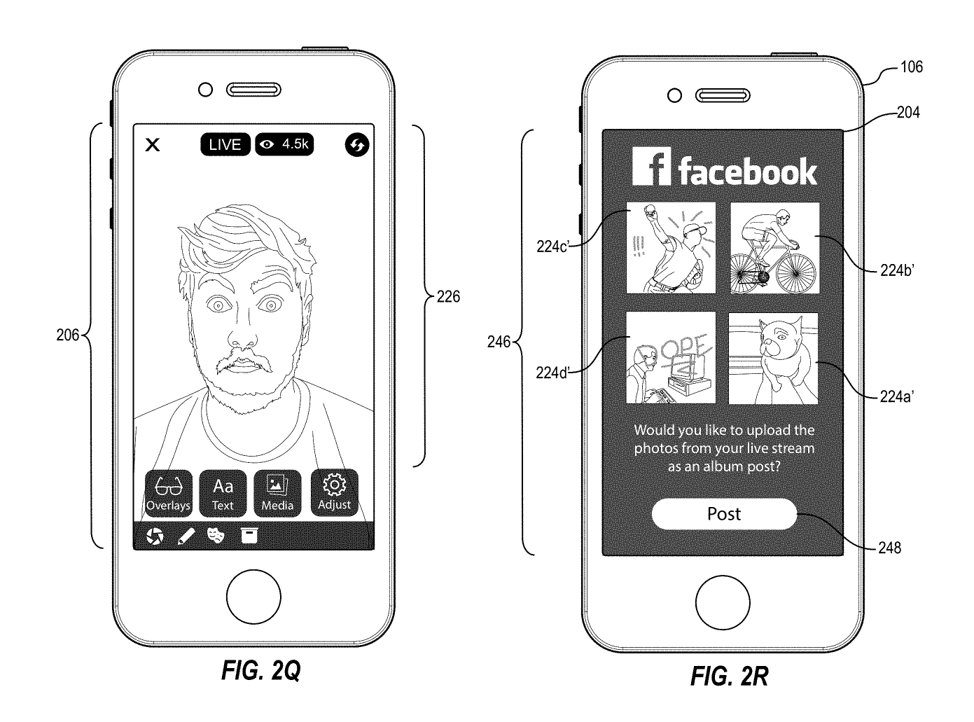

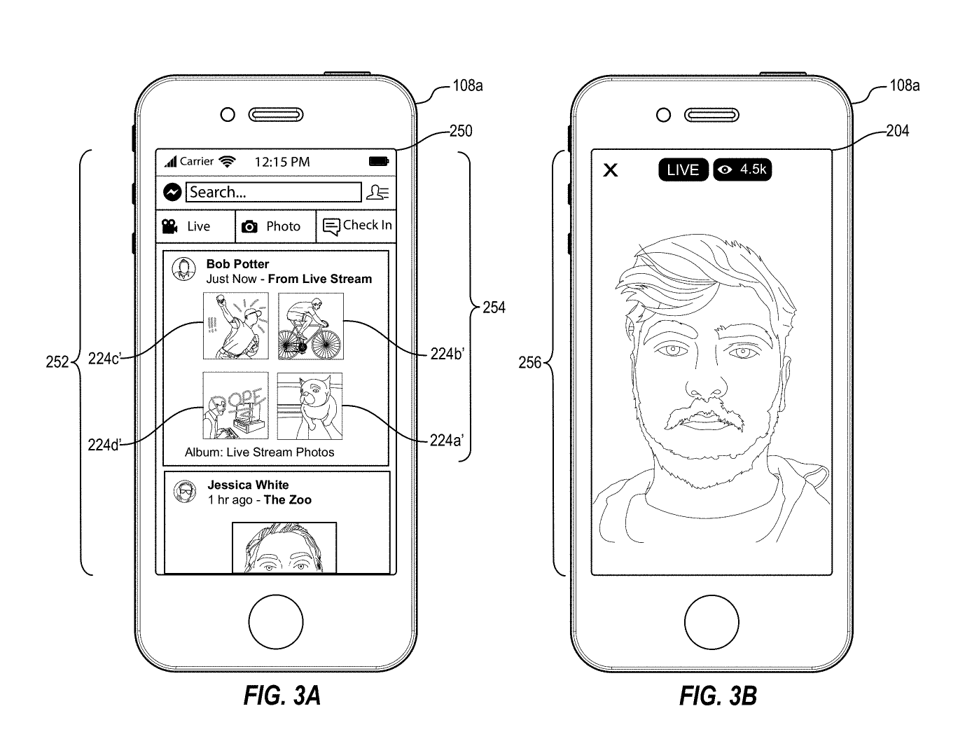

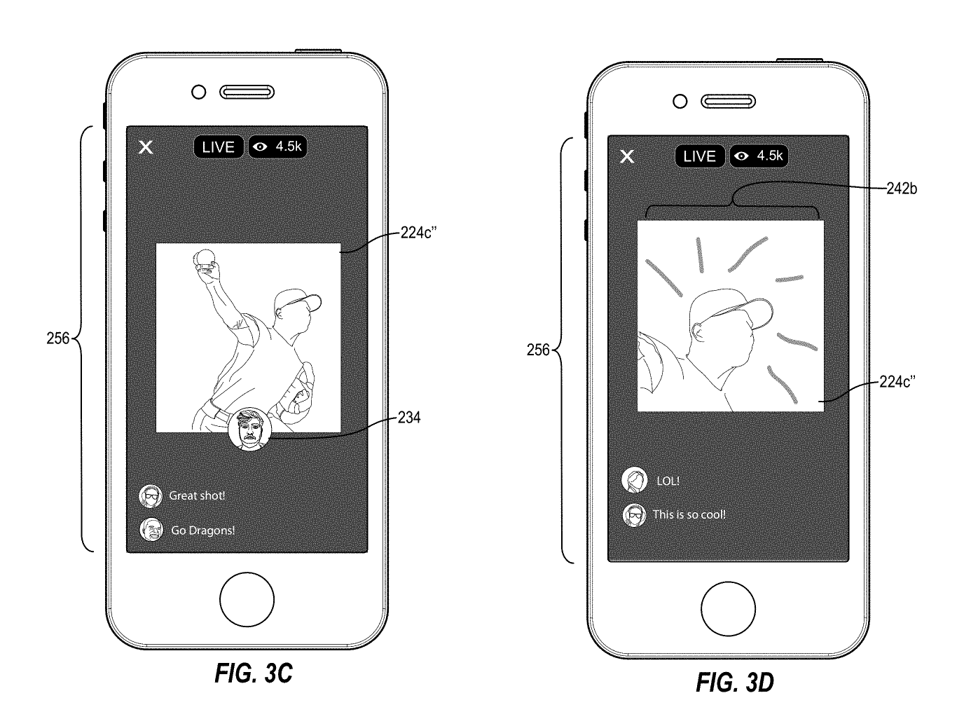

As will be described in more detail below, the components of the broadcast management system 100 provides, along and/or in combination with the other components, one or more graphical user interfaces (“GUIs”). In particular, the networking system application 110a, 110b, 110c, and 110d displays one or more GUIs generated by the networking system 104 and/or the networking system applications 110a-110d. The networking system application 110a (e.g., associated with the broadcaster) and the networking system applications 110b, 110c, and 110d (e.g., associated with the viewers) enable users (e.g., whether the broadcaster or the viewers) to interact with a collection of display elements provided within one or more GUIs for a variety of purposes. FIGS. 2A-3D and the description that follows illustrate various example embodiments of the GUIs that are used to describe the various features of the broadcast management system 100.

As mentioned above, the networking system 104 enables a broadcaster to initiate a live video broadcast from the broadcasting device 106. As used herein, a “live video broadcast” refers to a real-time video stream initiated at a client-computing device and provided to additional client-computing devices by a central host (e.g., the networking system 104). Also as used herein, the term “broadcaster” means a user of the networking system 104 who initiates or otherwise provides a live video presentation or stream at the broadcasting device 106. The broadcaster can be a person, merchant, business, or other organization. Also as used herein, the term “viewer” means a user of the networking system 104 who views a live video broadcast via the networking system 104. In one or more embodiments, in response to the broadcaster initiating a live video broadcast, the broadcast management system 100 provides a GUI including a display of the live video broadcast to client-computing devices associated with the broadcaster and one or more viewers. Furthermore, in at least one embodiment, the broadcast management system 100 provides different GUI functionality to the broadcaster than to the one or more viewers.

For example, as illustrated in FIG. 2A, the broadcasting device 106 includes a touch screen display 204. In one or more embodiments, the broadcast management system 100 provides the broadcaster GUI 206 in response to a detected indication that the broadcaster is initiating a live video broadcast (e.g., the broadcaster has selected a live video broadcast control within the networking system application 110a). For instance, the broadcaster GUI 206 displays a real-time view of the video stream originating at the broadcasting device 106. As shown in FIG. 2A, the broadcaster GUI 206 includes a display of a video stream of either a front-facing camera of the broadcasting device 106 (e.g., meaning the person depicted in the broadcaster GUI 206 is the broadcaster looking at himself while holding the broadcasting device 106), or the rear-facing camera view of the broadcasting device 106 (e.g., meaning the broadcaster is pointing the broadcasting device 106 at the person depicted in the broadcaster GUI 206).

As further shown in FIG. 2A, the broadcasting GUI 206 includes additional controls in the broadcast control tray 208 and the broadcast enhancement tray 210. For example, the broadcast control tray 208 includes the broadcast control buttons 212a, 212b, 212c, and 212d. In one or more embodiments and in response to a detected selection of the broadcast control button 212a, the broadcast management system 100 provides a selection of filters (e.g., black-and-white, sepia, etc.) that can be applied to the video stream displayed in the broadcaster GUI 206. Also, in one or more embodiments and in response to a detected selection of the broadcast control button 212b, the broadcast management system 100 provides a selection of doodle tools (e.g., tools that enable the broadcaster to “doodle” or draw over the video stream displayed in the broadcaster GUI 206. In one or more embodiments and in response to a detected selection of the broadcast control button 212c, the broadcast management system 100 provides a selection of virtual reality masks that can be applied to the video stream displayed in the broadcaster GUI 206. Further, in one or more embodiments and in response to a detected selection of the broadcast control button 212d, the broadcast management system 100 provides a selection of enhancement tools.

For example, as shown in FIG. 2A, in response to the detected selection of the broadcast control button 212d, the broadcast management system 100 provides the broadcast enhancement tray 210 including the broadcast enhancement buttons 214a, 214b, 214c, and 214d. In one or more embodiments and in response to a detected selection of the broadcast enhancement button 214a, the broadcast management system 100 provides a selection of overlays (e.g., borders, stickers, etc.) that can be applied to the video stream displayed in the broadcaster GUI 206. In one or more embodiments and in response to the detected selection of the broadcast enhancement button 214b, the broadcast management system 100 provides text tools that enable the broadcaster to add customized text to the video stream displayed in the broadcaster GUI 206. In one or more embodiments and in response to the detected selection of the broadcast enhancement button 214d, the broadcast management system 100 provides a selection of controls that enable the broadcaster to adjust the color, contrast, brightness, etc. of the video stream displayed in the broadcaster GUI 206.

In one or more embodiments and in response to the detected selection of the broadcast enhancement button 214c, the broadcast management system 100 enables the broadcaster to add a slide show of digital media items to the live video broadcast. For example, in response to a detected selection of the broadcast enhancement button 214c, as shown in FIG. 2A, the broadcast management system 100 replaces the broadcast control tray 208 and the broadcast enhancement tray 210 with the notification 216, as shown in FIG. 2B. In one or more embodiments, the notification 216 provides information regarding how the broadcaster can include digital media items into a live video broadcast.

In response to a detected selection of the button 218 (e.g., indicating the broadcaster understands the instructions given in the notification 216), the broadcast management system 100 splits the broadcaster GUI 206 into a live video display area 226 and a digital media preview area 228. In one or more embodiments, the live video display area 226 includes a display of the live video broadcast that the broadcast management system 100 is currently transmitting to the networking system 104 in real-time. Put another way, the live video display area 226 displays to the broadcaster exactly what the live video broadcast viewers are seeing. As shown in FIG. 2C, in response to the detected selection of the button 218, the broadcast management system 100 can split the broadcaster GUI 206 roughly in half horizontally. In other embodiments, the broadcast management system 100 can split the broadcaster GUI 206 vertically. Also in other embodiments, the broadcast management system 100 can split the broadcaster GUI 206 such that the live video display area 226 takes up more or less of the broadcaster GUI 206. Alternatively, the broadcast management system 100 can split the broadcaster GUI 206 into the live video display area 226 and the digital media preview area 228 in response to the detected selection of the broadcast enhancement button 214c.

As further illustrated in FIG. 2C, in at least one embodiment, the broadcast management system 100 includes the source selector buttons 220a and 220b in the digital media preview area 228. For example, as mentioned above, the broadcast management system 100 enables the broadcaster to include a slide show of digital media items from various sources in a live broadcast video. For instance, in response to a detected selection of the source selector button 220a, the broadcast management system 100 provides the camera roll 222 including digital media items 224a′, 224b′, 224c′, and 224d′. In at least one embodiment, the digital media items 224a′-224d′ are digital media items stored on the broadcasting device 106. For example, in at least one embodiment, the digital media items 224a′-224d′ are the most recent digital photographs or videos captured or downloaded by broadcasting device 106. In other embodiments, the digital media items 224a′-224d′ are the most recently accessed digital media items stored on the broadcasting device 106. Additionally, the camera roll 222 is horizontally scrollable, and can include any number of digital media items.

In one or more embodiments and in response to a detected selection of the source selector button 220b, the broadcast management system 100 provides a display of recent digital media items associated with the broadcaster via the networking system 104. For example, in response to the detected selection of the source selector button 220b, the broadcast management system 100 utilizes the broadcaster's networking system profile information (e.g., a unique networking system identifier associated with the broadcaster, an email address associated with the broadcaster, etc.) to access (e.g., download, copy) one or more digital media items that the broadcaster has recently utilized within the networking system for inclusion in a networking system post or message. For example, the broadcast management system 100 can provide digital media items that the broadcaster has recently uploaded to the networking system 104, digital media items that the broadcaster has recently interacted with via the networking system 104 (e.g., “liked,” commented on, etc.), digital media items that the broadcaster has recently included in networking system posts or electronic messages, and so forth.

Additionally or alternatively, in response to the detected selection of the source selector button 220b, the broadcast management system 100 may access only those digital media items with which the broadcaster has engaged with on more than a threshold level. For example, the broadcast management system 100 may only access the digital media items on which the broadcaster has commented, and not the digital media items the broadcaster has “liked.” After accessing one or more digital media items associated with the broadcaster's networking system profile, the broadcast management system can provide those digital media items within the digital media preview area 228 of the broadcaster GUI 206.

In additional embodiments, the broadcast management system 100 can provide additional sources from which the broadcaster can access digital media items. For example, in one embodiment, the broadcast management system 100 can access digital media items from cloud storage (e.g., a cloud storage account associated with the broadcaster). In another embodiment, the broadcast management system 100 can access digital media items from a web page in response to receiving a uniform resource locator (“URL”).

With reference again to FIG. 2C, in response to a detected selection of one of the provided digital media items (e.g., one of the digital media items 224a′-224d′), the broadcast management system 100 initiates a slide show within the live video broadcast. For example, in one or more embodiments, until the selection of one of the provided digital media items, the live video broadcast simply consists of a video stream captured by a camera of the broadcasting device 106. For instance, as shown in FIG. 2C, the live video display area 226 simply displays the video stream captured by the camera of the broadcasting device 106. Upon detecting a selection of a digital media item (e.g., the digital media item 224a′ in the camera roll 222), the broadcast management system 100 generates a composite video stream that includes the video stream as well as the selected digital media item and replaces the video stream in the live video broadcast with the generated composite video stream. In one or more embodiments, the broadcast management system 100 generates the composite video stream by generating a new video stream including the video stream from the camera of the broadcasting device 106 composited with a display of the selected digital media item. Thus, the networking system 104 receives the composite video stream generated by the broadcast management system 100 in the same way as it receives the standard video stream from the broadcasting device 106.

As shown in FIG. 2D, in response to a detected selection of a digital media item 224a′, the broadcast management system 100 replaces the display of the standard video stream with a composite video stream display including the video stream display 234 and the digital media item 224a″. As illustrated in FIG. 2D, the video stream display 234 includes a display of the video stream captured by a camera of the broadcasting device 106. Although the video stream display 234 is shown in FIG. 2D overlaid on a portion of the digital media item 224a″, in other embodiments, the broadcast management system 100 can include the video stream display 234 in a different area within the live video display area 226. Similarly, in other embodiments, the broadcast management system 100 can enlarge the video stream display 234 or move the video stream display 234 within the live video display area 226.

Also as shown in FIG. 2D, in response to a selection of the video stream selector button 232, the broadcast management system 100 can remove the video stream display 234 from the live video display area 226. For example, in response to a detected selection of the video stream selector button 232, the broadcast management system 100 also removes the video stream display 234 from the composite video stream generated at the broadcasting device 106. In response to another detected selection of the video stream selector button 232, the broadcast management system 100 can add the video stream display 234 to the live video display area 226 and to corresponding the composite video stream. In other words, the broadcast management system 100 toggles the inclusion of the video stream display 234 on and off within the live video display area 226 and the composite video stream in response to the selection of the video stream selector button 232.

Furthermore, at the broadcasting device 106, the broadcast management system 100 provides additional functionality for ease of use during a live video broadcast. For example, as shown in FIG. 2D, in response to the detected selection of the digital media item 224a′, the broadcast management system 100 displays the digital media item 224a″ in the live video display area 226. In one or more embodiments, the broadcast management system 100 creates the digital media item 224a′ as a thumbnail version (e.g., a lower resolution version) of the full-resolution digital media item 224a″. Thus, the digital media item 224a″ may include more display data (e.g., more pixels) than the digital media item 224a′, even though the digital media item 224a′ and the digital media item 224a″ appear to be differently sized versions of the same digital media item. Alternatively, in at least one embodiment, the digital media item 224a″ is simply an enlarged version of the digital media item 224a′.

Also in response to the detected selection of one of the provided digital media items, the broadcast management system 100 provides an indication as to which digital media item is currently viewable via the live video broadcast. For example, as shown in FIG. 2D, in response to the detected selection of the digital media item 224a′, the broadcast management system 100 overlays the currently live indicator 230 on the digital media item 224a′. In one or more embodiments, the currently live indicator 230 further indicates to the broadcaster that broadcast management system 100 has successfully composited the digital media item 224a″ into the composite video stream in the live video broadcast.

In one or more embodiments, viewers of a live video broadcast can engage with the broadcaster in various ways via the networking system. For example, in one embodiment, live video broadcast viewers can submit comments related to the live video broadcast, can “like” the live video broadcast, can share the live video broadcast, and so forth. In at least one embodiment, the broadcast management system 100 provides these viewer interactions to the broadcasting device 106 for display to the broadcaster. For instance, as shown in FIG. 2E, in response to a viewer submitting a comment in relation to the live video broadcast, the broadcast management system 100 can provide the comment 236 within the live video display area 226. As illustrated in FIG. 2E, the broadcast management system 100 can include a profile picture associated with the viewer who submitted the comment 236. Thus, the broadcast management system 100 provides the broadcaster with an additional way to engage with his viewers during the live video broadcast in a non-distracting way.

In at least one embodiment, the broadcast management system 100 enables the broadcaster to select additional digital media items on the fly for inclusion in the slide show during the live video broadcast. For example, as shown in FIG. 2F, in response to a detected selection of the digital media item 224b′, the broadcast management system 100 transitions the live video display area 226 to include the digital media item 224b″. Also as shown in FIG. 2F, the broadcast management system 100 move the currently live indicator 230 such that it is overlaid on the digital media item 224b′. Thus, by selecting different digital media items within the camera roll 222, the broadcaster can create a slide show of digital media items in any order in a manner that is quick and intuitive while the live video broadcast is ongoing. In this way, the broadcaster does not need to open any additional applications, windows, or displays in order to include a slide show during a live video broadcast.

In one or more embodiments, the broadcast management system 100 enables the broadcaster to interact with digital media items within the composite video stream during a live video broadcast. For example, the broadcast management system 100 enables the broadcaster to zoom in on a digital media item, zoom out from a digital media item, twist a digital media item, doodle on a digital media item, add text to a digital media item, add one or more overlays to a digital media item, add an audio track to the display of a digital media item, and so forth. To illustrate, as shown in FIG. 2G, in response to a detected user interaction with the live video display area 226 (e.g., a pinch-out touch gesture, a double-tap touch gesture, etc.), the broadcast management system 100 provides an enlarged view of the digital media item 224b″.

As shown in FIG. 2G, the broadcast management system 100 can provide the enlarged view such that the perimeter of the digital media item 224b″ does not change (i.e., the enlarged view is only of a portion of the digital media item 224b″). In another embodiment, the broadcast management system 100 can provide an enlarged view of the digital media item 224b″ with a variable perimeter such that the enlarged view fills a greater portion of the live video display area 226.

In at least one embodiment, the broadcast management system 100 can provide an enlarged view of the digital media item 224b″ that is a predefined percentage larger than the digital media item 224b″ (e.g., the enlarged view is 50% larger). Similarly, in at least one embodiment, the broadcast management system 100 can provide the enlarged view centered on a predefined point within the digital media item 224b″ (e.g., the center of the digital media item 224b″). Alternatively, in at least one embodiment, the broadcast management system 100 can provide the enlarged view based on the detected user interaction. For example, in one embodiment, in response to a pinch-out touch gesture, the broadcast management system 100 can provide an enlarged view of the digital media item 224b″ that is centered at a point corresponding to the beginning of the pinch-out touch gesture and enlarged in direct proportion with the spread of the pinch-out touch gesture. Additionally, in at least one embodiment, the broadcast management system 100 can provide a predefined enlarged view (e.g., 50% larger based on a central point in the digital media item) based on one type of user interaction (e.g., a double tap touch gesture), and a variable enlarged view corresponding to a second type of user interaction (e.g., a pinch-out touch gesture).

In one or more embodiments, as mentioned above, the broadcast management system 100 also enables the broadcaster to zoom-out from a digital media item. For example, as shown in FIG. 2H, in response to a user interaction (e.g., a pinch-in touch gesture), the broadcast management system 100 provides a reduced view of the digital media item 224b″ in any of the ways discussed above. In at least one embodiment, the broadcast management system 100 only allows for the broadcaster to zoom-out to the original resolution of the digital media item 224b″. In other embodiments, the broadcast management system 100 may allow for indefinite zoom-out by reducing the perimeter of the digital media item 224b″.

Additionally, as mentioned above, in one or more embodiments, the broadcast management system 100 enables the broadcaster to add enhancements such as text and doodles to a digital media item in the composite video stream. For example, as shown in FIG. 2I, in response to a detected selection of the editing tools selector button 238, the broadcast management system 100 replaces the camera roll 222 with the editing tools tray 240, as shown in FIG. 2J. In one or more embodiments, the editing tools tray 240 includes a doodle palette that enables the broadcaster to select a doodle color, a doodle width, a doodle pattern, and so forth. For instance, in response to a detected selection of one of the doodle colors in the editing tools tray 240 and detected user interactions (e.g., taps, press-and-slides, etc.) with the digital media item 224c″, the broadcast management system 100 adds the doodles 242a and 242b to the digital media item 224c″, as shown in FIG. 2K. In one or more embodiments, the broadcast management system 100 adds doodles 242a, 242b such that it appears as though the broadcaster is drawing on the digital media item 224c″.

In one or more embodiments, the broadcast management system 100 not only adds the doodles 242a, 242b to the digital media item 224c″ in the live video display area 226 on the broadcasting device 106, but also adds the doodles 242a, 242b to the composite video stream provided to the networking system 104. For example, in at least one embodiment and as will be discussed further below, the broadcast management system 100 adds the doodles 242a, 242b to the composite video stream such that, from a viewer device, it appears as though the broadcaster is drawing on the digital media item 224c″ in real-time. In this way, the broadcast management system 100 enables the broadcaster to draw viewers' focus to a particular area within the digital media item 224c″, to add visual excitement to the digital media item 224c″, and so forth.

In other embodiments, the editing tools tray 240 can include additional functionality (e.g., accessed in response to a side-swipe touch gesture, etc.). For example, the editing tools tray 240 can include additional tools that enable the broadcaster to add text to a digital media item, to add various overlays to a digital media item, to add an audio track to a digital media item, and so forth. Furthermore, in one or more embodiments, in order to allow the broadcaster to interact with the full-resolution digital media item 224c″, the broadcast management system 100 can remove the video stream display 234 from the live video display area 226 when the editing tools tray 240 is activated. Alternatively, the broadcast management system 100 can toggle the video stream display 234 on and off in response to selections of the video stream selector button 232.

Additionally, the broadcast management system 100 enables the broadcaster to zoom in and out on the digital media item 224c″, even after additional enhancements (e.g., doodles, text, etc.) are added to the digital media item 224c″ and to the corresponding composite video stream. For example, as shown in FIG. 2M, in response to a detected user interaction (e.g., a pinch-out touch gesture), the broadcast management system 100 provides an enlarged view of the digital media item 224c″, including the doodles 242a, 242b. As illustrated in FIG. 2M, once the doodles 242a, 242b are added to the digital media item 224c″, an enlargement or reduction of the digital media item 224c″ also enlarges or reduces the doodles 242a, 242b. Also illustrated in FIG. 2M, in some embodiments, in response to a detected user interaction (e.g., a pinch-out touch gesture), the broadcast management system 100 zooms in on the digital media item 224c″ such that the perimeter of the digital media item 224c″ grows to fill the live video display area 226, rather than keeping the perimeter of the digital media item 224c″ static (e.g., as shown in FIG. 2G above).

In addition to digital media items that are digital photographs, the broadcast management system 100 also enables digital media items that are digital videos to be included in a slide show during a live video broadcast. For example, in response to a detected selection of the digital media item 224d′, the broadcast management system 100 adds the digital media item 224d″ (e.g., a digital video) to the live video display area 226, as shown in FIG. 2N. In one or more embodiments, the broadcast management system 100 auto-plays all or a portion of the digital video associated with the digital media item 224d′ within the camera roll 222. In that case, the broadcast management system 100 mutes audio track volume as the associated digital video auto-plays.

Also, in response to the detected selection of the digital media item 224d′, the broadcast management system 100 adds the digital media item 224d″ to the composite video stream. In at least one embodiment, the broadcast management system 100 automatically begins playing the digital media item 224d″ once it is added to the live video display area 226. Furthermore, in at least one embodiment, the broadcast management system 100 mixes the audio track included in the video stream display 234 in with the audio track of the digital media item 224d″. In this way, the broadcaster can narrate over the digital media item 224d″, even if the digital media item 224d″ includes an audio track.

In one or more embodiments, as shown in FIG. 20, the broadcast management system 100 enables the broadcaster to add enhancements (e.g., doodles, text, overlays, etc.) to the digital media item 224d″, even though the digital media item 224d″ is a digital video. For example, as illustrated in FIG. 20, the broadcast management system 100 enables the broadcaster to add the doodle 242c to the digital media item 224d″. In one embodiment, the doodle 242c remains static as an overlay on the digital media item 224d″. In another embodiment, the broadcast management system 100 may anchor the doodle 242c to an object displayed in the digital media item 224d″. In that case, the broadcast management system 100 may reposition the doodle 242c relative to the anchor point, as the anchor point moves. In yet another embodiment, the broadcast management system 100 may display the doodle 242c for a predetermined amount of time (e.g., 5 seconds) before erasing the doodle 242c from the digital media item 224d″.

In at least one embodiment, the broadcast management system 100 provides various transitions to the slide show, in order to add another layer of engagement to the live video broadcast. For example, as shown in FIG. 2P, the broadcast management system 100 can transition the live video display area 226 by rotating the digital media item 224d″ around the video stream display 234. In other embodiments, the broadcast management system 100 can transition between digital media items within a slide show, or away from or back to a full view of the video stream in the live video display area with a fade-out transition, a slide transition, a pixelate transition, or any of a number of other transitions. For example, in response to a detected selection of the done button 244 as shown in FIG. 2P, the broadcast management system 100 can rotate the digital media item 224d″ around the video stream display 234, then can enlarge the video stream display 234 to fill the entire live video display area 226 of the broadcaster GUI 206, as shown in FIG. 2Q. In some embodiments, the broadcast management system 100 can allow the broadcaster to specify a desired transition setting. Alternatively, the broadcast management system 100 can randomly select transition settings for a slide show.

In at least one embodiment, the broadcast management system 100 enables the broadcaster to move backwards through a slide show that includes more than one digital media items. For example, the broadcast management system 100 can display a previously displayed digital item in response to detected a swipe gesture across the live video display area. In one or more embodiments, the broadcast management system 100 maintains any previously added enhancements (e.g., doodles, etc.) when displaying a digital media item in the slide show for the second time. In this way, the broadcast management system 100 gives the broadcaster the freedom to navigate through the slide show as desired.

Referring again to FIG. 2P, the broadcast management system 100 ends the slide show of digital media items within the live video broadcast in response to detecting a user interaction with the done button 244. In at least one embodiment, in response to ending the slide show, the broadcast management system 100 replaces the composite video stream with the standard video stream originating at the broadcaster device 106, as shown in FIG. 2Q. Thus, the live video broadcast now only includes the video stream from the broadcaster device 106, and the live video display area 226 of the broadcaster GUI 206 again includes a display of only the standard video stream.

In one or more embodiments, at the conclusion of a live video broadcast that included a slide show of digital media items, the broadcast management system 100 automatically generates a networking system album including the digital media items from the slide show. For example, as shown in FIG. 2R, in response to the detected conclusion of the live video broadcast described with reference to FIGS. 2A-2Q, the broadcast management system 100 provides the album upload GUI 246 on the touch screen display 204 of the broadcasting device 106. In at least one embodiment, the album upload GUI 246 includes a display of a networking system album generated by the broadcast management system 100 containing the digital media items 224a′-224d′ that were included in the slide show during the live video broadcast that just concluded. In other embodiments, the album upload GUI 246 is vertically or horizontally scrollable when there are more digital media items to display than fit within the touch screen display 204.

In some embodiments, the broadcast management system 100 enables the broadcaster to alter the generated networking system album in various ways. For example, the broadcast management system 100 enables the broadcaster to remove one or more digital media items from the generated networking system album. For instance, the broadcaster can remove a digital media item within the album upload GUI 246 by interacting (e.g., tapping on) a displayed digital media item. Additionally, the broadcast management system 100 enables broadcaster to add additional enhancements to a digital media item. The broadcast management system 100 can also enable the broadcaster to remove networking system activity (e.g., a comment) from a digital media item, or add a caption to one or more of the digital media items. Thus, in one or more embodiments, the broadcast management system 100 allows the broadcaster to review and edit the generated album prior to providing the album to the networking system 104.

In response to a detected selection of the post button 248, the broadcast management system 100 provides the networking system album including the indicated digital media items in the album upload GUI 246 to the networking system 104. Furthermore, in at least one embodiment and in response to generating the networking system album, the broadcast management system 100 also generates a networking system post regarding the album. For example, as shown in the networking system GUI displayed on the viewer device 108a in FIG. 3A, in response to a detected selection of the post button 248 by the broadcaster, the broadcast management system 100 generates and distributes the networking system post 254 to the newsfeed 252 of at least one networking system user. In one or more embodiments, the broadcast management system 100 distributes the networking system post 254 to all of the broadcaster's networking system co-users (e.g., the broadcasters “friends”). In another embodiment, the broadcast management system 100 may only distribute the networking system post 254 to networking system users who viewed a threshold amount of the now-ended live video broadcast. In yet another embodiment, the broadcast management system 100 may only distribute the networking system post 254 to networking system users who engaged in networking system activity related to the now-ended live video broadcast (e.g., users who liked a digital media item, users who submitted a comment, etc.).

As shown in FIG. 3A, the networking system post 254 identifies the broadcaster by his or her networking system profile information (e.g., the broadcaster's networking system profile picture and user name) and displays all or a portion of the digital media items (e.g., the digital media items 224a′-224c′) displayed during the now-ended live video broadcast and included in the generated networking system album. In at least one embodiment, the networking system post 254 can also include a recording of the now-ended live video broadcast. Furthermore, in at least one embodiment, in response to a detected selection to any of the digital media items included in the networking system post 254, the broadcast management system 100 can display a full-resolution version of the selected digital media item along with any networking system activity (e.g., comments, likes, etc.) received during the live video broadcast in association with that digital media item.

As mentioned above, in one or more embodiments, the broadcast management system 100 provides controls and tools to a live video broadcaster in the broadcaster GUI 206 that are not provided to viewers of the live video broadcast. For example, as shown in FIG. 3B, the broadcast management system 100 provides the viewer GUI 256 on the touch screen display 204 of the viewer device 108a to a viewer of a live video broadcast. In one or more embodiments, the viewer GUI 256 includes a full screen display of a live video broadcast provided by the networking system 104 and broadcast by the user of the broadcasting device 106.

As shown in FIG. 3C, when the live video broadcast includes a slide show of one or more digital media items (e.g., the digital media item 224c″), the viewer GUI 256 displays the digital media item composited with the video stream display 234. It will be understood that, in one or more embodiments, the contents of the viewer GUI 256 are received at the viewer device 108a as a single video stream from the networking system 104. In other words, the broadcasting device 106 composites separate elements (e.g., the video stream and various digital media items) into a composite video stream. In one or more embodiments, the composite video stream is received and distributed by the networking system 104 as a single video stream, in real-time. Accordingly, as shown in FIG. 3C, the viewer GUI 256 includes the same elements (e.g., digital media items, comments, likes, etc.) that are displayed on the broadcaster GUI 206 at substantially the same time during the live video broadcast.

Accordingly, as the broadcaster interacts with digital media items during a live video broadcast, the broadcast management system 100 continuously provides the video stream reflecting the broadcaster's interactions. For example, as shown in FIG. 3D, the viewer GUI 256 displays the live video broadcast including the broadcaster adding the doodle 242b to the digital media item 224c″ as well as a zoom in on the digital media item 224c″. As such, the viewer GUI 256 substantially mirrors the broadcaster GUI 206 in real-time without including the various tools described above with reference to the broadcaster GUI 206.

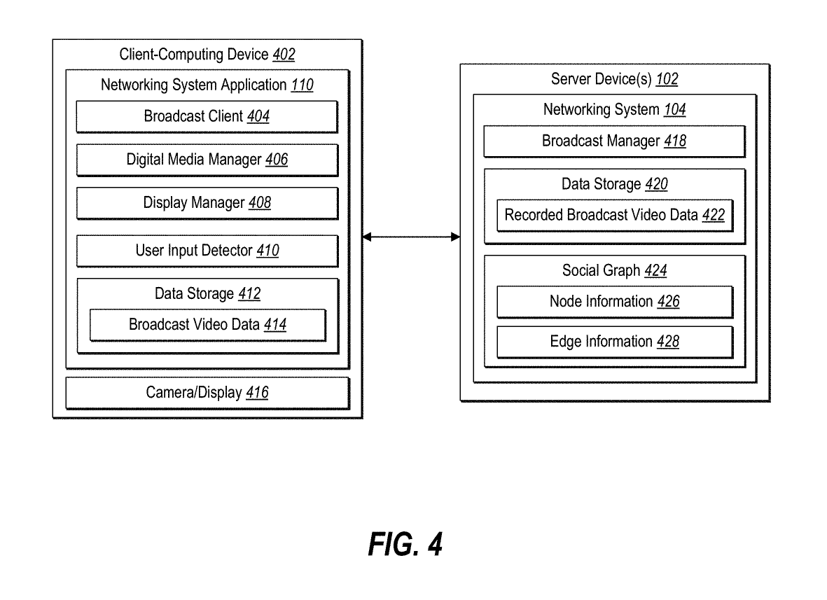

As discussed above, the systems and methods laid out with reference to FIGS. 1-3D enable a slide show of digital media items to be included in a live video broadcast. FIG. 4 illustrates a schematic diagram illustrating another example embodiment of the broadcast management system 100. As shown in FIG. 4, the broadcast management system 100 includes, but is not limited to, the client-computing device 402 including the networking system application 110, and the server device(s) 102 hosting the networking system 104.

In one or more embodiments, the client-computing device 402 is any of the broadcasting device 106, the viewer device 108a, the viewer device 108b, or the viewer device 108c. For example, as mentioned above, the broadcasting device 106 and the viewer devices 108a-108c may be the same type of computing device (e.g., a mobile computing device such as a smart phone). Furthermore, in at least one embodiment, the networking system application 110 includes the same functionality regardless of the type of computing device upon which the networking system application 110 is installed. In other words, the networking system application 110 includes the functionality that allows the user of the client-computing device 402 to both broadcast live video and to view live video broadcasts.

As shown in FIG. 4, the networking system application 110 includes a broadcast client 404, a digital media manager 406, a display manager 408, a user input detector 410, and a data storage 412 including broadcast video data 414. Also shown in FIG. 4, the networking system 104 includes a broadcast management 418, and a data storage 420 including recorded broadcast video data 422.

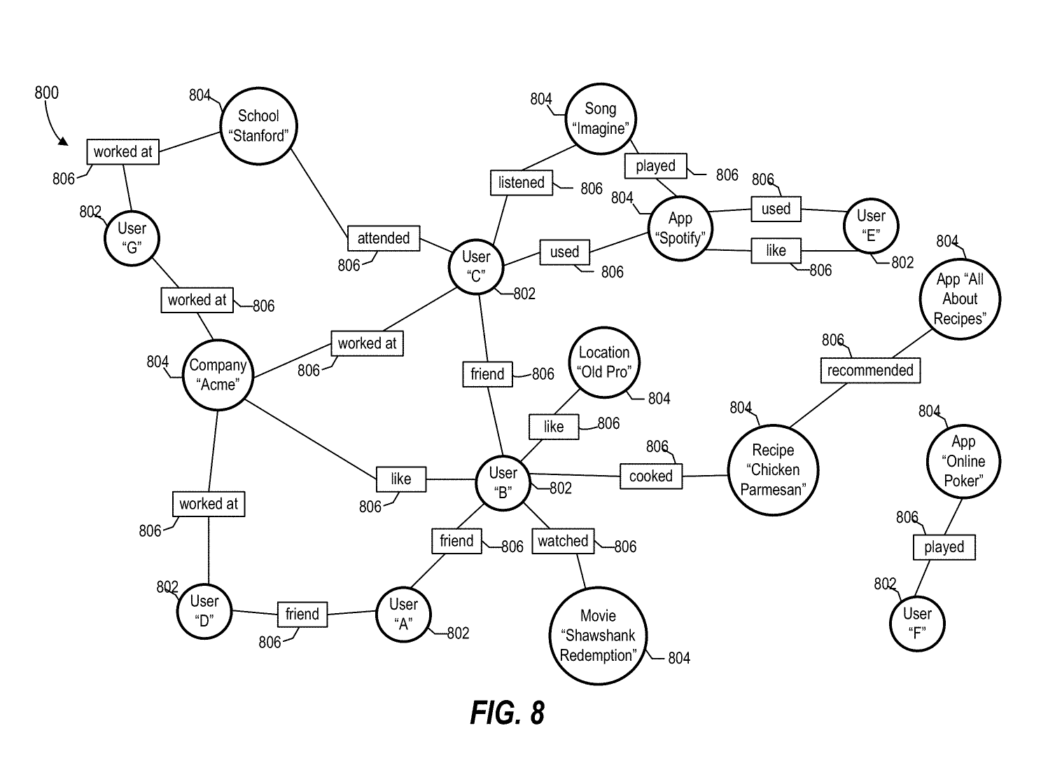

In at least one embodiment, the broadcast management system 100 accesses the networking system 104 in order to identify and utilize networking system data. Accordingly, the networking system 104 includes a social graph 424 for representing a plurality of users, actions, and concepts. In one or more embodiments, the social graph 424 includes node information 426 and edge information 428. Node information 426 of the social graph 424 stores information including, for example, nodes for users and nodes for repositories. Edge information 428 of the social graph 424 stores information including relationships between nodes and/or actions occurring within the networking system 104. Further details regarding the networking system 104, the social graph 424, edges, and nodes are presented below with respect to FIG. 8.

Each of the components 404-428 can be implemented using a computing device including at least one processor executing instructions that cause the broadcast management system 100 to perform the processes described herein. In some embodiments, the networking system components described herein can be implemented by the server device(s) 102, or across multiple server devices. Additionally or alternatively, a combination of one or more server devices and one or more mobile computing devices can implement the components of the networking system 104 and/or the networking system application 110. Additionally or alternatively, the components described herein can comprise a combination of computer-executable instructions and hardware.

In one or more embodiments, the networking system application 110 is a native application installed on the client-computing device 402. For example, the networking system application 110 can be a mobile application that installs and runs on a mobile device, such as a smart phone or a tablet computer. Alternatively, the networking system application 110 can be a desktop application, a widget, or other form of a native computer program. Furthermore, the networking system application 110 may be a remote application accessed by the client-computing device 402. For example, the networking system application 110 may be a web application that is executed within a web browser of the client-computing device 402.

As mentioned above, and as shown in FIG. 4, the networking system application 110 includes the broadcast client 404. In one or more embodiments, the broadcast client 404 handles all activities related to streaming or otherwise transmitting a live video broadcast from the client-computing device 402. For example, in at least one embodiment, the broadcast client 404 transmits or provides a video stream from the client-computing device 402 to the networking system 104. As discussed above, in response to a detected initiation of a live video broadcast by the user of the client-computing device 402 (e.g., the broadcaster), the broadcast client 404 accesses the video stream (e.g., a feed of image frames captured by an active camera associated with the client-computing device 402), and transmits the camera feed to the networking system 104 in real-time.

Additionally, the broadcast client 404 receives networking system activity information associated with a currently-live video broadcast. For example, in one or more embodiments, viewers of a live video broadcast can engage in networking system activities (e.g., comments, shares, likes, etc.) related to the live video broadcast. In order to enable the broadcaster and the live video broadcast viewers to have more immersive live experience, the networking system provides information associated with the networking system activities to the broadcast client 404 in real-time. In at least one embodiment, the broadcast client 404 displays the received information as part of an interface (e.g., the broadcaster GUI 206) for the user of the client-computing device 402.

In response to the inclusion of a slide show if digital media items in a currently-live video broadcast, the broadcast client 404 also generates a composite video stream. For example, as described above, in at least one embodiment, a live video broadcast generally begins with a video stream captured by a camera associated with the client-computing device 402. Then at some point during the live video broadcast, the broadcaster includes one or more digital media items in the live video broadcast, as discussed above. At that point, the broadcast client 404 generates a composite video stream that includes the video stream captured by the client-computing device camera (e.g., including both an audio track and a video track) and the one or more digital media items. In one or more embodiments, the broadcast client 404 can continue to generate the composite video stream until the broadcaster indicates that the slide show portion of the live video broadcast is ended.

The broadcast client 404 also receives any detected user interaction in connection with the with the digital media items included in the slide show during the live video broadcast, and embeds the corresponding enhancements in the composite video stream. For example, as discussed above, a broadcaster can zoom in, zoom out, doodle, add text, add overlays and so forth by performing various user interactions (e.g., touch gestures, voice commands, mobile device manipulations, etc.) in connection with a digital media item. Accordingly, in one or more embodiments, in response to detecting any preconfigured user interaction, the broadcast client 404 can embed the corresponding enhancement into the composite video. In at least one embodiment, the broadcast client 404 embeds the corresponding enhancement in real-time.

Additionally, in response to generating the composite video stream, the broadcast client 404 also provides the composite video stream to the networking system 104. In at least one embodiment, during a live video broadcast, the broadcast client 404 provides only one video stream to the networking system 104 at a time. Thus, if the broadcast client 404 is already providing a standard video stream the networking system 104 prior to generating the composite video stream, the broadcast client 404 replaces the standard video stream with the generated composite video stream. In one or more embodiments, the broadcast client 404 performs the replacement seamlessly and in real-time, such that there is no interruption in the transmission received by the networking system 104 from the client-computing device 402.

Also as shown in FIG. 4, the networking system application 110 further includes the digital media manager 406. In one or more embodiments, the digital media manager 406 handles all activities related to digital media items within a live video broadcast. For example, in one embodiment, the digital media manager 406 provides digital media items (e.g., the digital media items 224a′-224d′) within the broadcaster GUI 206 for the broadcaster to include in a slide show during a live video broadcast. To illustrate, in response to selection of the source selector button 220a, the digital media manager 406 queries or fetches one or more digital media items stored on the client-computing device 402. The digital media manager 406 then displays the retrieved digital media items in the broadcaster GUI 206.

In response to a selection of the source selector button 220b, the digital media manager 406 communicates a request (e.g., including identifying information associated with the user of the client-computing device 402) to the networking system 104 for one or more networking system posts associated with the user of the client-computing device 402. For example, the digital media manager 406 may request networking system posts that the user has posted himself, networking system posts that the user has “liked,” networking system posts with regard to which the user as commented, networking system posts the user has shared, and so forth. In response to receiving the networking system posts from the networking system 104, the digital media manager 406 also extracts digital media items (e.g., digital photographs, digital images, digital videos, etc.) from the received networking system posts.

The digital media manager 406 can also configure a networking system post including an album of digital media items after a live video broadcast ends. For example, in response to a broadcaster ending a live video broadcast, the digital media manager 406 can configure and generate a networking system album including the digital media items included in a slide show during the live video broadcast. In at least one embodiment, the digital media manager 406 also configures a networking system post related to the generated album for the networking system 104 to distribute to one or more networking system users. Accordingly, in one or more embodiments, the digital media manager 406 tracks all digital media items included in a live video broadcast slide show, along with other data related to the slide show. For example, the digital media manager 406 tracks the order in which the digital media items were selected by the broadcaster, the length of time during which each digital media items was displayed during the slide show, any enhancement added to each of the digital media items, and any networking system activity associated with each of the digital media items. Thus, in one or more embodiments, the digital media manager 406 includes this tracked information along with the digital media items in the generated networking system album.

After tracking the digital media items, and the data related to the slide show, the digital media manager 406 pre-populates a networking system post configuration display (e.g., the album upload GUI 246). For example, as shown in FIG. 2R, the digital media manager 406 pre-populates the networking system post configuration display with the digital media items included in the slide show during the most recent live video broadcast and enables the user of the client-computing device 402 to make alterations to the configuration of the resulting networking system album and networking system post. Then, in response to the user accepting the displayed configurations, the digital media manager 406 provides the networking system album and the networking system post configurations to the networking system 104. In one or more embodiments, the networking system 104 then generates and distributes the resulting networking system album and post to one or more networking system users.

As mentioned above, and as shown in FIG. 4, the networking system application 110 includes a display manager 408. The display manager 408 provides, manages, and/or controls a graphical user interface (“GUI”) that allows the user of the client-computing device 402 to interact with features of the broadcast management system 100. For example, in one or more embodiments, the display manager 408 facilitates the display of a GUI. For instance, the display manager 408 may compose the GUI of a plurality of graphical components, objects, and/or elements that allow a user to engage in networking system activities (e.g., broadcasting a live video, viewing a live video broadcast, commenting on a live video broadcast, configuring a slide show during a live video broadcast, etc.).

More particularly, the display manager 408 may direct the client-computing device 402 to display a group of graphical components, objects, and/or elements that enable a user to interact with various features of the networking system 104. To illustrate, the display manager 408 provides a GUI that allows a networking system user to select digital media items for inclusion in a slide show during a live video broadcast. In general, the display manager 408 provides graphical controls that allow a user to interact with or otherwise specify any type of content. For example, the term “content” is used herein to generally describe text, digital media items, files, location information, payment information, or any other data that can be utilized by the broadcast management system 100.

The display manager 408 also facilitates the input of text or other data for the purpose of interacting with one or more features of the networking system 104. For example, the display manager 408 provides a user interface that includes a touch screen display keyboard. A user can interact with the touch screen display keyboard using one or more touch gestures to input text for inclusion in a live video broadcast comment, networking system post, etc. In addition to text, the display manager 408 can also facilitate the input of various other characters, symbols, icons, or other information.

Furthermore, the display manager 408 is capable of transitioning between two or more graphical user interfaces. For example, in one embodiment, the display manager 408 provides a networking system newsfeed to a networking system user containing one or more networking system posts associated with other networking system users. Later, in response to a detected selection by the user of a networking system post associated with a live video broadcast, the display manager 408 transitions to a second GUI (e.g., the viewer GUI 256) that includes a display of the live video broadcast.

As further illustrated in FIG. 4, the networking system application 110 includes a user input detector 410. In one or more embodiments, the user input detector 410 detects, receives, and/or facilitates user input in any suitable manner. In some examples, the user input detector 410 detects one or more user interactions with respect to a GUI. As referred to herein, a “user interaction” means a single interaction, or combination of interactions, received from a user by way of one or more input devices. For example, the user input detector 410 detects a user interaction from a keyboard, mouse, touch screen display, and/or other input device. In the event the client-computing device 402 includes a touch screen display, the user input detector 410 detects one or more touch gestures (e.g., swipe gestures, tap gestures, pinch gestures, reverse pinch gestures, etc.) from a user that form a user interaction. In some examples, a user can provide the touch gestures in relation to and/or directed at one or more graphical objects or graphical elements of a GUI.

The user input detector 410 may additionally, or alternatively, receive data representative of a user interaction. For example, the user input detector 410 may receive one or more user configurable parameters from a user, one or more commands from the user, and/or any other suitable user input. The user input detector 410 may receive input data from one or more components of the networking system 104, or from one or more remote locations.

The networking system application 110 performs one or more functions in response to the user input detector 410 detecting user input and/or receiving other data. Generally, a user can control, navigate within, and otherwise use the networking system application 110 by providing one or more user inputs that the user input detector 410 can detect. For example, in response to the user input detector 410 detecting user input, one or more components of the networking system application 110 allow a networking system user to scroll through a newsfeed. In another example, in response to the user input detector 410 detecting user input, one or more components of the networking system application 110 allow the user to interact with a live video broadcast display.

In at least one embodiment, the user input detector 410 determines whether a detected user interaction is in connection with a live video broadcast display. For example, as described above, one or more features of the broadcast management system 100 provide a live video broadcast display, with which a viewer and/or a broadcaster can interact using various touch gestures (e.g., by tapping on a comment button, by tapping on a like button, etc.). Accordingly, the user input detector 410 can determine when, for example, a broadcaster's tap touch gesture is over a portion of a live video broadcast display that includes a digital media item. In response to determining that the touch gesture is over a portion of the live video broadcast display that includes the digital media item, the user input detector 410 can report the touch gesture to the broadcast client 404, or other component.

As further shown in FIG. 4, and as mentioned above, the networking system application 110 includes the data storage 412. The data storage 412 includes broadcast video data 414. In one or more embodiments, the broadcast video data 414 is representative of broadcast video information, such as described herein.

Additionally, in one or more embodiments, the client-computing device 402 also includes a camera/display 416. For example, in one or more embodiments the client-computing device 402 includes at least one camera (e.g., a smart phone camera or tablet computer camera) and at least one display (e.g., a touch screen display). In one or more embodiments, the camera and display features can be built-in, or peripheral. In additional embodiments, the client-computing device 402 can include multiple cameras and/or multiple displays.

As shown in FIG. 4, and as mentioned above, the server device(s) 102 hosts the networking system 104. The networking system 104 provides or otherwise distributes live video broadcasts, digital media items, networking system posts, electronic messages, etc. to one or more networking system users (e.g., by way of a newsfeed, a communication thread, a live video broadcast display, a timeline, a “wall,” or any other type of graphical user interface). For example, one or more embodiments provide a user with a networking system newsfeed containing posts from one or more networking system co-users associate with the user (e.g., the user's “friends”).

In one or more embodiments, a networking system user scrolls through his or her networking system newsfeed in order to view recent networking system posts submitted by the one or more co-users associated with the user via the networking system 104. In one embodiment, the networking system 104 organizes the networking system posts chronologically in a user's networking system newsfeed or wall. In alternative embodiments, the networking system 104 organizes the networking system posts geographically, by interest groups, according to a networking system coefficient between the user and the co-user, etc.

The networking system 104 also enables the user to engage in all other types of networking system activity. For example, the networking system 104 enables a networking system user to initiate or view live video broadcasts, scroll through newsfeeds, click on posts and hyperlinks, compose and submit electronic messages and posts, interact with multimedia (e.g., digital photographs and videos), and so forth.

As mentioned above, and as shown in FIG. 4, the networking system 104 includes a broadcast manager 418. In one or more embodiments, the broadcast manager 418 supports all activities involved in streaming, transmitting, or otherwise providing a live video broadcast. For example, the broadcast manager 418 receives a live video broadcast stream from the client-computing device 402. As described above, in response to a user of the client-computing device 402 (e.g., the broadcaster) initiating a live video broadcast at the client-computing device 402, the broadcast client 404 provides a video stream from the client-computing device 402 to the broadcast manager 418. In at least one embodiment, the broadcast manager 418, in turn, provides the received video stream to one or more networking system users as a live video broadcast in real-time. The broadcast manager 418 can similarly provide a composite video stream generated by the broadcast client 404 in real-time.

The broadcast manager 418 also records a received live video broadcast stream (e.g., whether as a video stream or a composite video stream) and provides the recording of the video broadcast in various ways. For example, depending on the broadcaster's preferences, the broadcast manager 418 generates and provides the recording of the video broadcast to all the broadcaster's networking system friends as a networking system post. In another embodiment, the broadcast manager 418 provides the recording of the video broadcast only to the networking system users who watched the live video broadcast via networking system notification. In yet another embodiment, the broadcast manager 418 provides the recording of the video broadcast to the networking system users who engaged in networking system activities associated with the live video broadcast. Additionally or alternatively, the broadcast manager 418 makes the recording of the video broadcast available via the broadcaster's networking system profile.

Furthermore, in one or more embodiments, the broadcast manager 418 receives, provides, and records networking system activity associated with a live video broadcast. For example, live video broadcast viewers engage in networking system activities (e.g., comments, posts, shares, likes, etc.) in connection with a live video broadcast. Accordingly, the broadcast manager 418 receives data detailing these networking system activities, and provides all of, or a portion of, the received data to the broadcast client 404. For example, in one embodiment, the broadcast manager 418 provides a comment received from a viewer and associated with a live video broadcast to the broadcast client 404 for display to the broadcaster.

As shown in FIG. 4, and as mentioned above, the networking system 104 includes the data storage 420. The data storage 420 includes recorded broadcast video data 422. In one or more embodiments, the recorded broadcast video data 422 is representative of recorded broadcast video information, such as described herein.

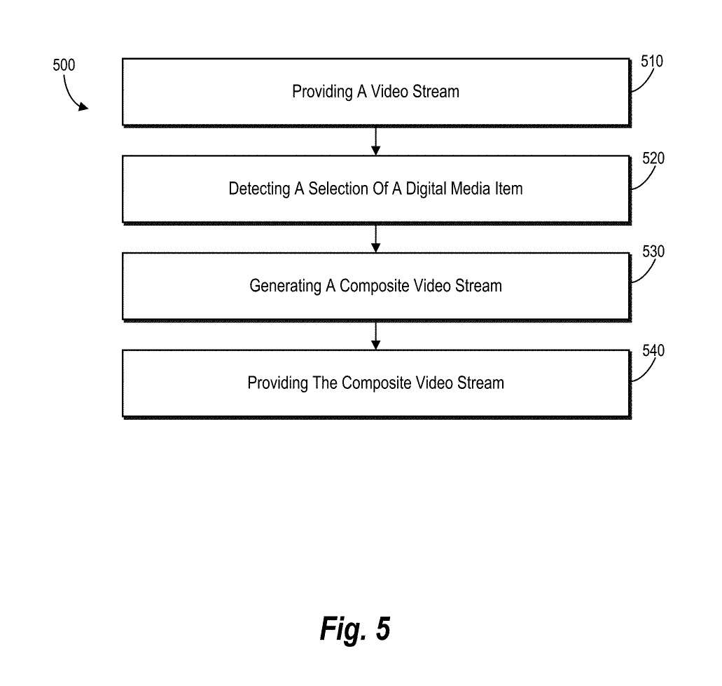

FIGS. 1-4, the corresponding text and examples, provide a number of different methods, systems, and devices for providing a slide show of digital media items in a live video broadcast. In addition to the foregoing, embodiments can also be described in terms of flowcharts comprising acts and steps in a method for accomplishing a particular result. For example, FIG. 5 may be performed with less or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of one example method 500 of providing a slide show of digital media items in a live video broadcast. The method 500 includes an act 510 of providing a video stream. In particular, the act 510 can involve providing, by a broadcasting device to a networking system for a live video broadcast, a video stream captured by a camera of the broadcasting device. For example, in at least one embodiment, providing the video stream captured by a camera of the broadcasting device happens in real-time.

The method 500 also includes an act 520 of detecting a selection of a digital media item. In particular, the act 520 can involve detecting, during the live video broadcast and by the broadcasting device, a selection of a digital media item. For example, the digital media item comprises one of a digital photograph thumbnail or a digital video thumbnail. Additionally, in some embodiments, the method 500 includes an act of presenting, by the broadcasting device, a plurality of digital media items stored by at least one of the broadcasting device of the networking system. For example, detecting a selection of a digital media item can include detecting a user interaction in connection with one of the plurality of digital media items. Furthermore, in one or more embodiments, the method 500 includes acts of receiving, from the networking system in response to providing a unique networking system identifier associated with a user of the broadcasting device, a plurality of networking system posts associated with the user of the broadcasting device; and extracting, from one or more of the received plurality of networking system posts, a plurality of digital media items comprising the selected digital medial item.

Additionally, the method 500 includes an act 530 of generating a composite video stream. In particular, the act 530 can involve generating, by the broadcasting device, a composite video stream comprising the captured video stream and the selected digital media item. For example, generating a composite video stream can include compositing the selected digital media item into the captured video stream in order to create a new video stream. In at least one embodiment, the composite video stream includes a display of the digital media item, and a display of the video stream captured by the camera of the broadcasting device overlaying a portion of the digital media item.

The method 500 further includes an act 540 of providing the composite video stream. In particular, the act 540 can involve providing, by the broadcasting device to the networking system during the live video broadcast, the composite video stream as a replacement for the video stream captured by the camera of the broadcasting device. For example, in one or more embodiment, providing the composite video stream to the networking system happens in real-time. Furthermore, the method 500 can include an act of providing, on a display of the broadcasting device and during the live video broadcast, the composite video stream. Additionally, the method 500 can include an act of, in response to a detected user interaction during the live video broadcast, replacing the composite video stream on the display of the broadcasting device with the video stream captured by the camera of the broadcasting device.

In some embodiments, the method 500 includes acts of detecting, while the composite video stream is provided to the networking system, a user interaction in connection with the composite video stream; and updating the provided composite video stream to reflect the detected user interaction. For example, updating the composite video stream to reflect the detected user interaction can include one or more of adding a doodle overlay to the selected digital media item, zooming in on the selected digital media item, zooming out from the selected digital media item, panning across the selected digital media item, twisting the selected digital media item, adding an audio track overlay to a display of the selected digital media item, fast-forwarding through the selected digital media item, rewinding through the selected digital media item, and applying a display filter to the digital media item.

The method 500 can also include acts of detecting, while the composite video stream is provided to the networking system, a selection of additional digital media items; and adding the additional digital media items to the composite video stream. Additionally, the method 500 can include acts of, after a conclusion of the live video broadcast, adding the selected digital media item and the additional digital media items to an album associated with the live video broadcast via the networking system; receiving, from the networking system, networking system activity associated with the album; and presenting the received networking system activity in association with the album.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the broadcast management system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage device 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the broadcast management system 100 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., posts, photo-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

FIG. 7 illustrates an example network environment 700 of a social networking system. Network environment 700 includes a client device 706, a networking system 702, and a third-party system 708 connected to each other by a network 704. Although FIG. 7 illustrates a particular arrangement of client device 706, networking system 702, third-party system 708, and network 704, this disclosure contemplates any suitable arrangement of client device 706, networking system 702, third-party system 708, and network 704. As an example and not by way of limitation, two or more of client device 706, networking system 702, and third-party system 708 may be connected to each other directly, bypassing network 704. As another example, two or more of client device 706, networking system 702, and third-party system 708 may be physically or logically co-located with each other in whole or in part. Moreover, although FIG. 7 illustrates a particular number of client devices 706, networking systems 702, third-party systems 708, and networks 704, this disclosure contemplates any suitable number of client devices 706, networking systems 702, third-party systems 708, and networks 704. As an example and not by way of limitation, network environment 700 may include multiple client device 706, networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client device 706, networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client device 706 may be an electronic device including hardware, software, or embedded logic components or a combination of two or more such components and capable of carrying out the appropriate functionalities implemented or supported by client device 706. As an example and not by way of limitation, a client device 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 706. A client device 706 may enable a network user at client device 706 to access network 704. A client device 706 may enable its user to communicate with other users at other client devices 706.

In particular embodiments, client device 706 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client device 706 one or more Hyper Text Markup Language (HTML) files responsive to the HTTP request. Client device 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, networking system 702 may be a network-addressable computing system that can host an online social network. Networking system 702 may generate, store, receive, and send social-networking data, such as, for example, user-profile data, concept-profile data, social-graph information, or other suitable data related to the online social network. Networking system 702 may be accessed by the other components of network environment 700 either directly or via network 704. In particular embodiments, networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, a networking system 702, or a third-party system 708 to manage, retrieve, modify, add, or delete, the information stored in data store.

In particular embodiments, networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Networking system 702 may provide users of the online social network the ability to communicate and interact with other users. In particular embodiments, users may join the online social network via networking system 702 and then add connections (e.g., relationships) to a number of other users of networking system 702 that they want to be connected to. Herein, the term “friend” may refer to any other user of networking system 702 with whom a user has formed a connection, association, or relationship via networking system 702.

In particular embodiments, networking system 702 may provide users with the ability to take actions on various types of items or objects, supported by networking system 702. As an example and not by way of limitation, the items and objects may include groups or social networks to which users of networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in networking system 702 or by an external system of third-party system 708, which is separate from networking system 702 and coupled to networking system 702 via a network 704.

In particular embodiments, networking system 702 may be capable of linking a variety of entities. As an example and not by way of limitation, networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating networking system 702. In particular embodiments, however, networking system 702 and third-party systems 708 may operate in conjunction with each other to provide social-networking services to users of networking system 702 or third-party systems 708. In this sense, networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client device 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, networking system 702 also includes user-generated content objects, which may enhance a user's interactions with networking system 702. User-generated content may include anything a user can add, upload, send, or “post” to networking system 702. As an example and not by way of limitation, a user communicates posts to networking system 702 from a client device 706. Posts may include data such as status updates or other textual data, location information, photos, videos, links, music or other similar data or media. Content may also be added to networking system 702 by a third-party through a “communication channel,” such as a newsfeed or stream.

In particular embodiments, networking system 702 may include a variety of servers, sub-systems, programs, modules, logs, and data stores. In particular embodiments, networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Networking system 702 may also include suitable components such as network interfaces, security mechanisms, load balancers, failover servers, management-and-network-operations consoles, other suitable components, or any suitable combination thereof. In particular embodiments, networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking networking system 702 to one or more client devices 706 or one or more third-party system 708 via network 704. The web server may include a mail server or other messaging functionality for receiving and routing messages between networking system 702 and one or more client devices 706. An API-request server may allow a third-party system 708 to access information from networking system 702 by calling one or more APIs. An action logger may be used to receive communications from a web server about a user's actions on or off networking system 702. In conjunction with the action log, a third-party-content-object log may be maintained of user exposures to third-party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of networking system 702. A privacy setting of a user determines how particular information associated with a user can be shared. The authorization server may allow users to opt in to or opt out of having their actions logged by networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client devices 706 associated with users. Advertisement-pricing modules may combine social information, the current time, location information, or other suitable information to provide relevant advertisements, in the form of notifications, to a user.

FIG. 8 illustrates example social graph 800. In particular embodiments, networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a networking system 702, client device 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of networking system 702. As an example and not by way of limitation, a user may be an individual (human user), an entity (e.g., an enterprise, business, or third-party application), or a group (e.g., of individuals or entities) that interacts or communicates with or over networking system 702. In particular embodiments, when a user registers for an account with networking system 702, networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with networking system 702. In particular embodiments, a user node 802 may be associated with information provided by a user or information gathered by various systems, including networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with networking system 702 or a third-party website associated with a web-application server); an entity (such as, for example, a person, business, group, sports team, or celebrity); a resource (such as, for example, an audio file, video file, digital photo, text file, structured document, or application) which may be located within networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to networking system 702. Profile pages may also be hosted on third-party websites associated with a third-party system 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 706 to send to networking system 702 a message indicating the user's action. In response to the message, networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, networking system 702 may send a “friend request” to the second user. If the second user confirms the “friend request,” networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to a edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, networking system 702 may create an edge 806 between a user node 802 and a concept node 804 in social graph 800. As an example and not by way of limitation, a user viewing a concept-profile page (such as, for example, by using a web browser or a special-purpose application hosted by the user's client device 706) may indicate that he or she likes the concept represented by the concept node 804 by clicking or selecting a “Like” icon, which may cause the user's client device 706 to send to networking system 702 a message indicating the user's liking of the concept associated with the concept-profile page. In response to the message, networking system 702 may create an edge 806 between user node 802 associated with the user and concept node 804, as illustrated by “like” edge 806 between the user and concept node 804. In particular embodiments, networking system 702 may store an edge 806 in one or more data stores. In particular embodiments, an edge 806 may be automatically formed by networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through networking system 702) or RSVP (e.g., through networking system 702) to an event associated with the advertisement. In addition or as an alternative, an advertisement may include social-networking-system context directed to the user. As an example and not by way of limitation, an advertisement may display information about a friend of the user within networking system 702 who has taken an action associated with the subject matter of the advertisement.

In particular embodiments, networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, networking system 702 may calculate a coefficient based on a user's actions. Networking system 702 may monitor such actions on the online social network, on a third-party system 708, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, networking system 702 may calculate a coefficient based on the user's actions with particular types of content. The content may be associated with the online social network, a third-party system 708, or another suitable system. The content may include users, profile pages, posts, news stories, headlines, instant messages, chat room conversations, emails, advertisements, pictures, video, music, other suitable objects, or any combination thereof. Networking system 702 may analyze a user's actions to determine whether one or more of the actions indicate an affinity for subject matter, content, other users, and so forth. As an example and not by way of limitation, if a user may make frequently posts content related to “coffee” or variants thereof, networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, networking system 702 may calculate a coefficient based on the type of relationship between particular objects. Referencing the social graph 800, networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than a user node 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, networking system 702 may determine that the user has a higher coefficient with respect to the first photo than the second photo because having a tagged-in-type relationship with content may be assigned a higher weight and/or rating than having a like-type relationship with content. In particular embodiments, networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 706 of the user). A first user may be more interested in other users or concepts that are closer to the first user. As an example and not by way of limitation, if a user is one mile from an airport and two miles from a gas station, networking system 702 may determine that the user has a higher coefficient for the airport than the gas station based on the proximity of the airport to the user.

In particular embodiments, networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, networking system 702 may provide information that is relevant to user's interests and current circumstances, increasing the likelihood that they will find such information of interest. In particular embodiments, networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, networking system 702 may calculate the coefficient (or access the coefficient information if it has previously been calculated and stored). In particular embodiments, networking system 702 may measure an affinity with respect to a particular process. Different processes (both internal and external to the online social network) may request a coefficient for a particular object or set of objects. Networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, and U.S. patent application Ser. No. 13/632869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by networking system 702 or shared with other systems (e.g., third-party system 708). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 708, particular applications (e.g., third-party applications, external websites), other suitable users or entities, or any combination thereof Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, networking system 702 may send a request to the data store for the object. The request may identify the user associated with the request and may only be sent to the user (or a client device 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions thereon that, when executed by at least one processor, cause a client device to:
provide, to a networking system for a live video broadcast, a video stream captured by a camera of a broadcasting device;
detect, during the live video broadcast, a selection of a digital media item;
generate a composite video stream comprising the captured video stream and the selected digital media item; and
provide to the networking system during the live video broadcast, the composite video stream as a replacement for the video stream captured by the camera of the broadcasting device.

2. The non-transitory computer-readable medium as recited in claim 1, further storing instructions thereon that, when executed by at least one processor, cause a client device to:
present a plurality of digital media items stored by at least one of the broadcasting device or the networking system; and
detect the selection of the digital media item by detecting a user interaction in connection with one of the plurality of digital media items.

3. The non-transitory computer-readable medium as recited in claim 1, further storing instructions thereon that, when executed by at least one processor, cause a client device to:
receive, from the networking system in response to providing a unique networking system identifier associated with a user of the broadcasting device, a plurality of networking system posts associated with the user of the broadcasting device; and
extract, from one or more of the received plurality of networking system posts, a plurality of digital media items comprising the selected digital medial item.

4. The non-transitory computer-readable medium as recited in claim 1, wherein the digital media item comprises one of a digital photograph thumbnail or a digital video thumbnail.

5. The non-transitory computer-readable medium as recited in claim 1, further storing instructions thereon that, when executed by at least one processor, cause a client device to:
detect, while the composite video stream is provided to the networking system, a user interaction in connection with the composite video stream; and
update the composite video stream to reflect the detected user interaction.

6. The non-transitory computer-readable medium as recited in claim 5, wherein updating the composite video stream to reflect the detected user interaction comprises one or more of adding a doodle overlay to the selected digital media item, zooming in on the selected digital media item, zooming out from the selected digital media item, panning across the selected digital media item, twisting the selected digital media item, adding an audio track overlay to a display of the selected digital media item, fast-forwarding through the selected digital media item, rewinding through the selected digital media item, or applying a display filter to the digital media item.

7. The non-transitory computer-readable medium as recited in claim 1, further storing instructions thereon that, when executed by at least one processor, cause a client device to:
detect, while the composite video stream is provided to the networking system, a selection of additional digital media items; and
add the additional digital media items to the composite video stream.

8. The non-transitory computer-readable medium as recited in claim 7, further storing instructions thereon that, when executed by at least one processor, cause a client device to:
after a conclusion of the live video broadcast, add the selected digital media item and the additional digital media items to an album associated with the live video broadcast via the networking system;
receive, from the networking system, networking system activity associated with the album; and
present the received networking system activity in association with the album.

9. The non-transitory computer-readable medium as recited in claim 1, further storing instructions thereon that, when executed by at least one processor, cause a client device to:
provide, on a display of the broadcasting device and during the live video broadcast, the composite video stream and a plurality of options for adding content to the live video broadcast, wherein the plurality of options are not included in the composite video stream; and
in response to a detected user interaction during the live video broadcast, replace the composite video stream on the display of the broadcasting device with the video stream captured by the camera of the broadcasting device.

10. The non-transitory computer-readable medium as recited in claim 1, wherein the composite video stream comprises a display of the digital media item, and a display of the video stream captured by the camera of the broadcasting device overlaying a portion of the digital media item.

11. A method comprising:
receive, by a networking system from a broadcasting device for a live video broadcast, a video stream captured by a camera of the broadcasting device;
receiving, during the live video broadcast and from the broadcasting device, a composite video stream comprising the captured video stream and a selected digital media item;
providing, during the live video broadcast and to a plurality of viewer devices, the composite video stream as a replacement for the video stream captured by the camera of the broadcasting device.

12. The method as recited in claim 11, further comprising presenting, to the user of the broadcasting device, a plurality of digital media items to facilitate selection of the digital media item from the plurality of digital media items.

13. The method as recited in claim 12, further comprising:
receiving a unique networking system identifier associated with a user of the broadcasting device; and
providing, in response to receiving the unique networking system identifier, a plurality of networking system posts associated with the user of the broadcasting device, the plurality of networking system posts comprising one or more of the plurality of digital media items.

14. The method as recited in claim 13, wherein the digital media item comprises one of a digital photograph thumbnail or a digital video thumbnail.

15. The method as recited in claim 14, further comprising:
receiving, during the live video broadcast, data representative of a user interaction with the composite video stream; and
providing, to the plurality of viewer devices, an updated composite video stream reflecting the user interaction.

16. The method as recited in claim 15, wherein the updated composite video stream reflects one or more of adding a doodle overlay to the selected digital media item, zooming in on the selected digital media item, zooming out from the selected digital media item, panning across the selected digital media item, twisting the selected digital media item, adding an audio track overlay to a display of the selected digital media item, fast-forwarding through the selected digital media item, rewinding through the selected digital media item, or applying a display filter to the digital media item.

17. The method as recited in claim 16, further comprising:
receiving, during the live video broadcast, the composite video stream comprising a selection of additional digital media items; and
providing, to the plurality of viewer devices, the composite video stream comprising the additional digital media items.

18. The method as recited in claim 17, further comprising:
receiving, in response to a detected user interaction during the live video broadcast, the video stream captured by the camera of the broadcasting device as a replacement of the composite video stream.

19. The method as recited in claim 11, wherein the composite video stream comprises a display of the digital media item, and a display of the video stream captured by the camera of the broadcasting device overlaying a portion of the digital media item.

20. A system comprising:
at least one processor; and
at least one non-transitory computer-readable storage medium storing instructions thereon that, when executed by the at least one processor, cause the system to:
receive, from a broadcasting device for a live video broadcast, a video stream captured by a camera of the broadcasting device;
receive, during the live video broadcast and from the broadcasting device, a composite video stream comprising the captured video stream and a selected digital media item;
provide, during the live video broadcast and to a plurality of viewer devices, the composite video stream as a replacement for the video stream captured by the camera of the broadcasting device.
